(19) United States
(12) Patent Application Publication
(10) Pub. No.: US 2025/0174669 A1
(43) Pub. Date: May 29, 2025

(54) HOST MATERIAL FOR RECHARGEABLE ZINC ANODES IN AQUEOUS BATTERIES

(71) Applicant: GEORGIA TECH RESEARCH CORPORATION, Atlanta, GA (US)

(72) Inventors: Nian LIU, Atlanta, GA (US); Evan WILSON, Atlanta, GA (US); Zhitao CHEN, Atlanta, GA (US)

(21) Appl. No.: 18/834,435

(22) PCT Filed: Feb. 2, 2023
(86) PCT No.: PCT/US2023/012179

§ 371 Date: Jul. 30, 2024

Related U.S. Application Data
(60) Provisional application No. 63/305,798, filed on Feb. 2, 2022.

(51) Int. Cl. H01M 4/62; H01M 4/02; H01M 4/04; H01M 4/42; H01M 10/26; H01M 50/417; H01M 50/426; H01M 50/429; H01M 50/446

(52) U.S. Cl. CPC H01M 4/628; H01M 4/0402; H01M 4/42; H01M 4/625; H01M 4/626; H01M 10/26; H01M 50/417; H01M 50/426; H01M 50/4295; H01M 50/446; H01M 2004/027; H01M 2300/0005

(57) ABSTRACT

Disclosed is an electrochemical cell comprising: an anode electrode, wherein the anode electrode comprises a conductive host material having a layered or a porous structure and comprising an amount of at least one zinc-alloying metal, wherein the conductive host material is configured to accommodate zinc metal deposition during a plating cycle and wherein the deposited zinc metal is substantially free of dendrites; an aqueous electrolyte; and wherein the anode electrode exhibits at least 50% utilization.

### CROSS-REFERENCE TO RELATED APPLICATIONS

This application claims the priority benefit of U.S. Provisional Patent Application Ser. No. 63/305,798, filed Feb. 2, 2022, entitled “HOST MATERIAL FOR RECHARGEABLE ZINC ANODE IN AQUEOUS BATTERIES,” which application is hereby incorporated by this reference in its entirety.

### STATEMENT ACKNOWLEDGING GOVERNMENT SUPPORT

This invention was made with government support under Grant No. FA8649-21-P-0047 awarded by the United States Air Force Research Lab (AFRL). The government has certain rights in the invention.

### TECHNICAL FIELD

This application relates generally to host materials for rechargeable zinc anodes to allow the stable operation of electrochemical cells.

### BACKGROUND

With the rapid increase in portable electronics and the global push towards vehicle electrification and smart grids, there is an increasing demand for large-scale, sustainable, eco-friendly, safe electrochemical energy storage systems (such as batteries, for example) with high energy/power density.

However, research in rechargeable batteries is mainly concentrated on lithium-based batteries. However, these batteries currently require non-aqueous electrolytes that often are toxic and hard to dispose of, posing environmental risks.

Water-based electrolyte-based rechargeable batteries with safety, high power, and large capacity can represent a sustainable alternative to lithium batteries. Especially the aqueous electrolyte battery with zinc metal anode has broad application prospects due to its abundance, high stability, low cost and non-toxic characteristics. However, this type of alkaline battery still has disadvantages due to the corrosivity of alkaline electrolytes, the formation of dendrites and the like. In addition, the existing water-based zinc batteries still have a small volume and capacity. If the volume is increased, the electrode and the current collector area will be increased correspondingly, which will lead to a relatively uneven distribution of voltage and current through the battery that can lead to a local over-potential on the surface of the positive electrode and, as a result, zinc salt precipitation can occur. Also, the surface of the negative electrode generates a local overpotential, which further promotes dendrite growth, zinc salt precipitation, and a larger current areal density. It is also easier to produce more side reactions. Therefore, if a large-volume water-based zinc battery needs to be obtained, it is necessary to solve the problems of dendrites and channel blockage.

These needs and other needs are at least partially satisfied by the present disclosure.

### SUMMARY

The present disclosure is directed to an electrochemical cell comprising: an anode electrode, wherein the anode electrode comprises a conductive host material having a layered and/or a porous structure and comprising an amount of at least one zinc-alloying metal; wherein the conductive host material is configured to accommodate zinc metal deposition during a plating cycle and wherein the deposited zinc metal is substantially free of dendrites; an aqueous electrolyte; and wherein the anode electrode exhibits at least 50% utilization.

In further aspects, the conductive host material comprises a chemically expanded graphene or graphite, a metal foam, conductive polymer, porous metal, or any combination thereof.

While in still further aspects, the at least one zinc-alloying metal comprises silver, gold, copper, tin, antimony, alloys thereof, or any combination thereof.

In still further aspects, also disclosed is an electrochemical cell comprising: an anode electrode, wherein the anode electrode comprises a conductive host material and comprising an amount of at least one zinc-alloying metal; wherein the conductive host material is configured to accommodate zinc metal deposition during a plating cycle and wherein the deposited zinc metal is substantially free of dendrites; an aqueous electrolyte; and wherein the anode electrode exhibits at least 50% utilization and has a capacity from 1 mAh/cm² to 200 mAh/cm².

Also disclosed is a system comprising any of the disclosed herein electrochemical cells.

Also disclosed herein is an article comprising any of the disclosed herein electrochemical cells or systems.

In further aspects, disclosed herein is a method of making an electrochemical cell comprising: a) depositing an amount of at least one zinc-alloying metal on a conductive host material having a layered and/or a porous structure; and b) plating a zinc metal on the conductive host material to form an anode electrode; wherein the anode electrode exhibits at least 50% utilization and is substantially free of dendrites.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1B is an exemplary schematic showing the differences between conventional zinc foil anode and a host material according to one aspect of the disclosure.

FIGS. 2A-2C depict production and testing illustrations. FIG. 2A shows a product of one lab-scale Zn anode host production run according to one aspect of the disclosure. FIG. 2B shows pressed anodes of host material at low mas loading according to another aspect of the disclosure. FIG. 2C shows a beaker cell assembled and undergoing cycle testing of the anode Zn host paired with an air cathode in one aspect of the disclosure.

FIGS. 3A-3F show Scanning Electron Microscopy images of Chemically Expanded Graphite (CEG) and Ag-seeded CEG (Ag·CEG). FIG. 3A shows a 400× magnification of CEG, showing an open pore structure. Inset shows 30× magnification so that the expansion of a single graphite flake can be seen fully. FIG. 3B shows 400× magnification of Ag·CEG. Inset shows a 100,000× magnification so that the adherence of Ag nanoparticles to the graphitic surface can be seen better. FIG. 3C shows a cross section SEM 100× magnification of Ag-seeded CEG/Carbon Nanotube (CNT) Composite (Ag·CEG·CNT) pressed anode, not loaded with Zn. FIG. 3D shows a cross section SEM 500× magnification of a pressed anode, not loaded with Zn, showing an open pore structure. FIG. 3E shows a cross section SEM 100× magnification of Ag·CEG·CNT pressed anode, loaded with Zn. FIG. 3F shows a cross section SEM 500× magnification of a pressed anode loaded with Zn, showing that the pore structure has been filled in.

FIGS. 4A-4C show the Beaker cell cycling data for Zinc-Air batteries using Ag·CEG·CNT zinc host. FIG. 4A shows a cycling voltage profile with 100% host utilization. The anode of this battery had areal host mass loading of 3.7 mg/cm². The battery was charged with 1 mA/cm² anode current density and discharged with 0.5 mA/cm² anode current density, with host charging and discharging at 1000 mAh/g specific capacity. FIG. 4B shows a host-to-foil comparison beaker cell platform. FIG. 4C shows the cycling voltage profiles of the host and foil overlaid at the equivalent charging cycle.

FIGS. 5A-5G show deep and shallow cycling of Ag·CEG·CNT 3D zinc host composite electrode material. After an activation step, the two cells were fully charged at 1 mA/cm² to 1 mAh/mg. The deeply cycled anode was discharged to 0V, and the shallowly cycled anode was discharged for 1 mAh or to a 0.8V voltage cutoff. Both were discharged at 0.5 mA/cm². FIG. 5A shows a single charge and discharge voltage profile of the deep cycling with a low mass loading case. FIG. 5B shows Coulombic Efficiency and charge/discharge specific capacity of the deep cycling with low mass loading case. FIG. 5C shows the shallow cycling voltage profile with a high mass loading case. FIG. 5D shows Coulombic Efficiency and charge/discharge specific capacity of the shallow cycling with low mass loading case. FIG. 5E shows an anode loaded with 2.6 mg host used for the deep cycling case. FIG. 5F shows an anode loaded with 10 mg of host used for the shallow cycling case. FIG. 5F shows a beaker cell bottom of the shallow cycling zinc-air case after the conclusion of cycle testing.

FIGS. 6A-6C show an SEM image of an exemplary alloy-seeded hosted (ASH-1) electrode according to one aspect of the disclosure (FIG. 6A). Graphene and Zn particles can be clearly identified. FIG. 6B shows a voltage profile of the exemplary ASH-1 electrode shown in FIG. 6A tested with Zn foil counter electrode. FIG. 6C shows the cycling stability of ASH-1 electrodes shown in FIG. 6A with different areal loadings.

FIGS. 7A-7C depict a photograph of an exemplary 3-inch×3-inch ASH-2 electrode according to another aspect of the disclosure. FIG. 7B shows a voltage profile of an exemplary ASH-2 electrode of FIG. 7A tested with Zn foil counter electrode. FIG. 7C shows the cycling stability of the ASH-2 electrodes of FIG. 7A with different areal loadings.

FIGS. 8A-8F depict a low-magnification SEM (FIG. 8B) and high-magnification SEM (FIG. 8C) of an ASH-1 electrode (FIG. 8A). FIG. 8E shows a low-magnification SEM, and FIG. 8F shows a high-magnification SEM of an ASH-2 electrode (FIG. 8D).

FIGS. 9A-9C depict voltage profiles of three cells containing ˜30 mAh/cm² ASH-2 working electrode and a Zn foil counter electrode at early cycles: Cell 1 (FIG. 9A), Cell 2 (FIG. 9B) and Cell 3 (FIG. 9C).

FIGS. 10A-10C depict voltage profiles of the three cells of FIGS. 9A-9C over 200 hours.

FIGS. 11 shows the mass loading and cycling performance of the three cells in FIGS. 9A-9C and FIGS. 10A-10C.

FIGS. 12A-12C show voltage profiles of (FIG. 12A) Cell 1 with 41 mAh/cm² two-side coated ASH-1 electrode shown in FIG. 8A, (FIG. 12B) Cell 2 with 42.3 mAh/cm² ASH-2 electrode shown in FIG. 8D and (FIG. 12C) Cell 3 with 63.3 mAh/cm² ASH-2 electrode shown in FIG. 8D.

FIGS. 13A-13C show in-situ EIS battery testing experiment results. FIG. 13A shows a voltage profile of battery cycling. FIG. 13B shows the EIS results of the battery before cycling. FIG. 13C shows the EIS results of the battery after each cycle.

FIG. 14 shows the mass loading and cycling performance of the three cells in FIGS. 12A-12C.

FIGS. 15A-15F depict photos of exemplary separators. Anode side: FIG. 15A—Whatman glass fiber, FIG. 15B—Celgard, and FIG. 15C—fluorinated grafted polypropylene/polyethylene separator. Cathode side: FIG. 15D—Whatman glass fiber, FIG. 15E—Celgard, and FIG. 15F—fluorinated grafted polypropylene/polyethylene separator after 20 cycles of stripping/plating at 40 mA. Here the term “anode” refers to an electrode that oxidizes at the time of an assembly.

FIGS. 16A-16D show photos of the separators after a half cycle: anode side (FIG. 16A) and cathode side (FIG. 16B) of fluorinated grafted polypropylene/polyethylene separator; and after one cycle: anode side (FIG. 16C), and cathode side (FIG. 16D) of fluorinated grafted polypropylene/polyethylene separator.

FIGS. 17A-17I show a low-magnification SEM (FIG. 17A), higher-magnification SEM (FIG. 17B), and cross section SEM (FIG. 17C) of a pristine ASH electrode prepared according to one aspect of the current disclosure. Low-magnification SEM (FIG. 17D), higher-magnification SEM (FIG. 17E), and cross section SEM (FIG. 17F) of an ASH electrode were prepared according to one aspect of the current disclosure after one-time Zn stripping. Low-magnification SEM (FIG. 17G), higher-magnification SEM (FIG. 17H), and cross section SEM (FIG. 17I) of an ASH electrode prepared according to one aspect of the current disclosure after one full cycle.

FIGS. 18A-18C show mass loading and cycling performance (FIG. 18A) and voltage profile of two cells (FIGS. 18B-18C) with fluorinated grafted polypropylene/polyethylene separator.

FIG. 19 shows the cycling stability of ASH electrodes according to some aspects of this disclosure with different areal loadings

FIGS. 20A-20B show voltage profiles of ASH electrodes according to some aspects of this disclosure with different areal loadings.

FIGS. 21A-21C show the voltage profile of ASH electrodes according to some aspects of this disclosure using slurry-coated counter electrodes.

FIG. 22 shows photographs of large ASH electrodes prepared according to some aspects of this disclosure.

The accompanying figures, which are incorporated in and constitute a part of this specification, illustrate several aspects described below.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a salt” includes two or more such elements, and a reference to “a battery” includes two or more such batteries and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise. It is further understood that these phrases are used for explanatory purposes only. It is further understood that the term “exemplary” means “an example of” and is not intended to convey an indication of a preferred or ideal aspect.

The expressions “ambient temperature” and “room temperature” as used herein are understood in the art and refer generally to a temperature from about 20° C. to about 35° C.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Values can be expressed herein as an “average” value. “Average” generally refers to the statistical mean value.

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

The term “or combinations thereof” as used herein refers to all permutations and combinations of the listed items preceding the term. For example, “A, B, C, or combinations thereof” is intended to include at least one of A, B, C, AB, AC, BC, or ABC, and if the order is important in a particular context, also BA, CA, CB, CBA, BCA, ACB, BAC, or CAB. Continuing with this example, expressly included are combinations that contain repeats of one or more items or terms, such as BB, AAA, AB, BBC, AAABCCCC, CBBAAA, CABABB, and so forth. The skilled artisan will understand that typically there is no limit on the number of items or terms in any combination unless otherwise apparent from the context.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Electrochemical Cells

Disclosed herein is an electrochemical cell comprising: an anode electrode, wherein the anode electrode comprises a conductive host material having a layered and/or a porous structure and comprising an amount of at least one zinc-alloying metal, wherein the conductive host material is configured to accommodate zinc metal deposition during a plating cycle and wherein the deposited zinc metal is substantially free of dendrites; an aqueous electrolyte; and wherein the anode electrode exhibits at least 50% utilization.

In still further aspects, the electrochemical cells disclosed herein can exhibit anode utilization of at least 55%, at least 60%, at least 65%, at least 70%, at least 75%, at least 80%, at least 85%, at least 90%, at least 95% or 100%. In yet still, further aspects, the electrochemical cells disclosed herein can show anode utilization from 55% to 100%, including exemplary values of 60%, 65%, 70%, 75%, 80%, 85%, 90%, and 95%.

In still further aspects, any known in the art conductive host materials suitable for the desired purpose can be utilized. In certain aspects, the conductive host material can comprise a chemically expanded graphene, chemically expanded graphite, metal foam, conductive polymer, porous metal, or any combination thereof. In aspects where the metal form is used, the metal foam can comprise nickel, platinum, copper, titanium, alloys thereof, or a combination thereof.

In still further aspects where the conductive host material comprises conductive polymers, such polymers can include, for example, and without limitations, polyaniline, polyacetylene, polyphenylene vinylene, polypyrrole, polythiophene, polyphenylene sulfide, or any combination thereof.

It is understood that the host material does not have to be porous. In certain aspects, the host material can be a thin conductive film, carbon paper, and the like.

In yet still further aspects, the specific thickness of the host material can be determined by the desired mass load of zinc metal during the cell operation and can range from 1 mg/cm² to 1 g/cm², including exemplary values of 2 mg/cm², 5 mg/cm², 10 mg/cm², 15 mg/cm², 20 mg/cm², 25 mg/cm², 30 mg/cm², 35 mg/cm², 40 mg/cm², 45 mg/cm², 50 mg/cm², 55 mg/cm², 60 mg/cm², 65 mg/cm², 70 mg/cm², 75 mg/cm², 80 mg/cm², 85 mg/cm², 90 mg/cm², and 95 mg/cm².

In still further aspects, it is understood that the zinc-alloying metals are any metals capable of forming an alloy material with zinc. In still further aspects, the zinc-alloying metals have solubility in zinc greater than 0. In still further aspects, the at least one zinc-alloying metal comprises silver, gold, copper, tin, antimony, alloys thereof, or any combination thereof. In yet still further aspects, the at least one zinc-alloying metal is silver (Ag).

In still further aspects, the at least one zinc-alloying metal can be present as nanoparticles or microparticles. In yet still further aspects, the at least one zinc-alloying metal can have any size from 100 nm to 100 μm, including exemplary values of 250 nm, 500 nm, 750 nm, 1 μm, 10 μm, 20 μm, 30 μm, 40 μm, 50 μm, 60 μm, 70 μm, 80 μm, and 90 μm.

In still further aspects, the at least one zinc-alloying metal can be incorporated into the host material by any known in the art methods. For example, the at least one zinc-alloying metal can be evaporated, deposited from the solution, slurry-coated, electroplated, sputtered, or incorporated by any combination of these methods. In still further aspects, the at least one zinc-alloying metal can be randomly incorporated into the host material. While in other aspects, the at least one zinc-alloying metal can be incorporated into the host material in a predetermined pattern.

In aspects where the host material is porous and/or layered, the at least one zinc-alloying metal can be incorporated within the pores or between the layers of the material and/or a surface of the host material.

In still further aspects, the host material can comprise up to 50 wt % of the at least one zinc-alloying metal, including exemplary values of 1 wt %, 5 wt %, 10 wt %, 15 wt %, 20 wt %, 25 wt %, 30 wt %, 35 wt %, 40 wt %, and 45 wt %, calculated on the total mass of the host material and the at least one zinc-alloying metal).

In still further aspects, disclosed herein are electrochemical cells wherein the conductive host material further comprises an amount of zinc metal before the plating cycle begins. In such exemplary and unlimiting aspects, the zinc metal present in the conductive host material before the plating cycle begins can be in a ratio of 1:1, 2:1, 3:1, 4:1, 5:1, 6:1, 7:1, 8:1, 9:1, or 10:1 to the amount of the at least one zinc-alloying metal.

In certain aspects, the at least one zinc-alloying metal behaves as a nucleation seed for the zinc metal deposition.

In still further aspects, the zinc metal can be deposited within the porous structure and/or between the layers of the conductive host material during the plating cycle. Without wishing to be bound by any theory, it is hypothesized that the at least one zinc-alloying metal facilitates zinc plating. In aspects where the conductive host material is not porous, during the plating cycle, zinc metal is disposed on a surface of the host material, where the plating is facilitated by the at least one zinc-alloying metal.

In still further aspects, zinc plated during the plating cycle is substantially free of dendrites.

In still further aspects, the conductive host material can further comprise carbon black, carbon nanotubes, and graphene. In some aspects, carbon black and/or carbon nanotubes can be functionalized to tune the desired properties of the host material. In yet still further aspects, the conductive host material can further comprise a binder. Exemplary binders can include carboxymethyl cellulose, styrene-butadiene, polyacrylonitrile, polyvinylidene fluoride, any combination thereof, and the like.

In still further aspects, the electrolyte can comprise one or more zinc salts. In certain aspects, the one or more zinc salts comprise zinc sulfate, zinc acetate, zinc citrate, zinc iodide, zinc chloride, zinc perchlorate, zinc nitrate, zinc phosphate, zinc triflate, zinc tetrafluoroborate, zinc bromide, zinc trifluoromethanesulfonate, zinc bis(trifluoromethanesulfonyl)imide, zinc bis(pentafluoroethylsulfonyl)imide, or a combination thereof. It is understood that the concentration of the one or more zinc salts can be in any desired range, for example and without limitations, the concentration of the salt can be from 0.1 M to 3 M, including exemplary values of 0.2 M, 0.5 M, 0.8 M, 1 M, 1.2 M, 1.5 M, 1.8 M, 2 M, 2.2M 2.5 M, and 2.8 M.

In still further aspects, the aqueous electrolyte has a pH from 4 to less than 8, including exemplary values of 4.5, 5, 5.5, 6, 6.5, 7, and 7.5.

In still further aspects, the electrochemical cells disclosed herein are batteries. In yet still further aspects, the electrochemical cell further comprises a cathode material. In such aspects, any cathodes suitable for the desired application can be utilized. In certain aspects, the cathode material comprises MnO₂, or any other manganese-based cathodes, VS₂, Fe₂O₂, V₂O₅, Prussian blue, vanadium-based cathodes, activated carbon, or Br₂.

In still further aspects where the electrochemical cell is a battery, it can comprise a separator. In such aspects, any known in the art suitable for the desired operation separator can be utilized. In certain aspects, the separator comprises ceramic or glass particles or fibers embedded in a polymeric matrix of textile fibers; cellulose-based film, polypropylene films, polypropylene/polyethylene films, fluorinated grafted polypropylene/polyethylene films, or a combination thereof.

In still further aspects, it is understood that the cells disclosed herein can have any desired size.

In still further aspects, the anode electrode of the disclosed herein electrochemical cell has a capacity from 1 mAh/cm² to 200 mAh/cm², including exemplary values of 5 mAh/cm², 10 mAh/cm², 20 mAh/cm², 30 mAh/cm², 40 mAh/cm², 50 mAh/cm², 60 mAh/cm², 70 mAh/cm², 80 mAh/cm², 90 mAh/cm², 100 mAh/cm², 110 mAh/cm², 120 mAh/cm², 130 mAh/cm², 140 mAh/cm², 150 mAh/cm², 160 mAh/cm², 170 mAh/cm², 180 mAh/cm², and 190 mAh/cm².

In still further aspects, the battery exhibits a charge-discharge Coulombic efficiency of the cell greater than 80% for at least 50 cycles. In further aspects, the battery can exhibit a charge-discharge Coulombic efficiency of the cell from 80% to 100%, including exemplary values of 85%, 90%, 95%, and 99% for at least 50 cycles. In still further aspects, the battery exhibits a charge-discharge Coulombic efficiency of the cell greater than t 99% for at least 50 cycles.

In still further aspects, the battery exhibits a charge-discharge Coulombic efficiency of the cell greater than 80% for at least 100 cycles, at least 200 cycles, at least 300 cycles, at least 400 cycles, at least 500 cycles, at least600 cycles, at least 700 cycles, or at least 1,000 cycles.

In stilly further aspects, the battery can exhibit a charge-discharge Coulombic efficiency of the cell from 80% to 100%, including exemplary values of 85%, 90%, 95%, and 99% for at least 100 cycles, at least 200 cycles, at least 300 cycles, at least 400 cycles, at least 500 cycles, at least 600 cycles, at least 700 cycles, or at least 1,000 cycles.

In yet still further aspects, the battery exhibits a capacity retention of at least 75%, at least 80%, at least 85%, at least 90%, at least 95%, or at least 99%, over at least 500 cycles.

In still further aspects, also disclosed is an electrochemical cell comprising: an anode electrode, wherein the anode electrode comprises a conductive host material and comprising an amount of at least one zinc-alloying metal; wherein the conductive host material is configured to accommodate zinc metal deposition during a plating cycle and wherein the deposited zinc metal is substantially free of dendrites; an aqueous electrolyte; and wherein the anode electrode exhibits at least 50% utilization and has a capacity from 1 mAh/cm² to 200 mAh/cm².

In certain aspects, disclosed herein are systems that can comprise two or more of the disclosed herein electrochemical cells. In certain aspects, the systems can comprise at least 10, at least 100, at least 500, between 10 and 10,000, between 100 and 10,000, between 1,000 and 10,000, between 10 and 1000, between 100 and 1,000, or between 500 and 1,000 electrochemical cells of the present disclosure. Cells in such systems may be arranged in parallel or in series.

In still further aspects, disclosed herein are articles comprising any of the disclosed herein electrochemical cells or systems. In such aspects, the articles can comprise hand-held and/or wearable electronic devices, such as a phone, watch, or laptop computer; stationary electronic devices, such as a desktop or mainframe computer; an electric tool, such as a power drill; an electric or hybrid land, water, or air-based vehicles, such as a boat, submarine, bus, train, truck, car, motorcycle, moped, powered bicycle, airplane, drone, other flying vehicle, or toy versions thereof; for other toys. In still further aspects, the electrochemical cells disclosed herein can be used for energy storage, such as in storing electric power from wind, solar, wave, hydropower, or nuclear energy and/or in grid storage, or as a stationary power store for small-scale use, such as for a home, business, or hospital.

Also disclosed herein are the methods of making the disclosed electrochemical cells. In some aspects, a method of making an electrochemical cell can comprise: a) depositing an amount of at least one zinc-alloying metal on a conductive host material having a layered and/or a porous structure; and b) plating a zinc metal on the conductive host material to form an anode electrode; wherein the anode electrode exhibits at least 50% utilization and is substantially free of dendrites. As discussed above, the at least one zinc-alloying metal can be deposited by electroplating, evaporation, slurry-coating, sputtering, solution deposition and the like.

In still further aspects, the conductive host material having a deposited zinc-alloying metal is positioned in an aqueous electrolyte comprising at least one zinc-containing salt prior to the step (b) of plating the zinc metal. In yet still further aspects, the method further comprises providing a cathode electrode. In still further aspects, the methods comprise forming a battery by positioning a separator between the anode half-cell and cathode half-cell of the battery.

By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Example 1

### Alloy-Seeding Zinc Host

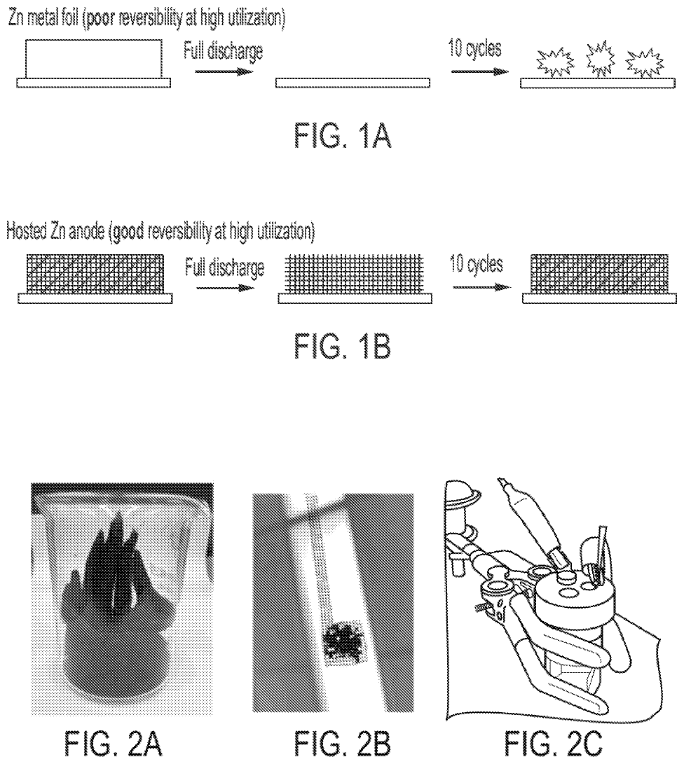

In almost all existing literature on rechargeable Zn-air batteries, thick (>200 μm) zinc metal foils were used as the anodes, which limits the utilization and cycle life. As illustrated in FIG. 1A, when a zinc foil is fully utilized in cycling, which is necessary to approach its theoretical capacity, it vanishes in a few cycles because of the shape change. The much longer cycle life (e.g., 100 cycles) in most literature is obtained by only utilizing ˜1 mAh/cm² areal capacity in each cycle (a typical 250 μm thick zinc metal foil has 145 mAh/cm²). To the best of the inventors' knowledge, there has been no report of rechargeable zinc anode with 50% or higher utilization.

This disclosure demonstrates the development of alloy-seeded hosted (ASH) Zn anodes that exhibit increased utilization and simultaneously extend the cycle life. As shown in FIG. 1B, the disclosed anodes have a conductive host material (e.g., carbon) that is decorated with a zinc-alloying metal (e.g., Ag). The host accommodates the zinc during deposition, and the Ag decoration spatially controls the zinc deposition inside the host.

In one example, the conductive host comprises a chemically expanded graphite-based host material. The disclosed anode materials can stabilize zinc cycling in the aqueous batteries and thus improve battery performance. The disclosure demonstrates that the chemically expanded graphite-based host material can enhance the rechargeability of zinc anode (e.g., for zinc-ion batteries) at a high percentage of active material utilization. The methods of making the same chemically expanded graphite-based host material are also disclosed.

### Mildly Acidic Zinc-Air Battery Chemistry

One major challenge confronting alkaline Zinc-Air batteries is the absorption of carbon dioxide from the air, which reacts with KOH, precipitates as potassium carbonate, and clogs the pores of cathode materials, severely limiting cycle life. This mechanism of battery failure is avoided by using a neutral or mildly acidic electrolyte without using heavy and costly systems to pre-scrub CO₂ from the air being fed to the air cathode.
Alkaline Zinc-Air Clogging

CO_{2(aq)}2KOH_{(aq)}→K₂CO_{3(aq)}+H₂O₍ₗ₎

Neutral/mildly acidic electrolytes for zinc-air batteries include Zinc Sulfate (ZnSO4) and Zinc Trifluoromethanesulfonate (Zn(OTf)₂), and Zinc Bis(trifluoromethanesulfonyl)imide (Zn(TFSI)₂). The electrolytes with fluorinated anions form Zinc Peroxide (ZnO₂) discharge products on air cathodes, whereas zinc sulfate electrolyte forms zinc sulfate hydroxide. Density Functional Theory (DFT) and Molecular Dynamics (MD) simulations suggest that this difference is due to the locally hydrophobic conditions brought at the cathode surface by the CF₃ groups on the electrolyte, similar to the “water in salt” concept familiar in LIB research. The cathode reaction with fluorinated electrolyte anion is notable because it is a single electron reduction per oxygen atom rather than a two-electron reduction, as is the case for more conventional Zinc-Air chemistries. According to quantum chemistry calculations, this single electron reduction on the zinc peroxide surface is expected to enable greater rate performance and more reversible cycling due to lower activation energy in the Oxygen Reduction Reaction (ORR). Electrolytes of 1 mol/L Zn(OTf)₂ were used in this disclosure.

The reactions occurring in mildly acidic Zinc-Air are as follows:
Electro-Oxidation of Zinc (at the anode):

Zn₍ₛ₎→Zn_{(aq)}²⁺+2e⁻
Electro-Reduction of Oxygen (at the cathode):

Zn_{(aq)}²+2e⁻+O_{2(g)|}→ZnO₂₍ₛ₎
Overall Zinc-Air Reaction:

Zn₍ₛ₎+O_{2(g)}→ZnO₂₍ₛ₎

### Chemically Expanded Graphite Host (CEG)

In this work, the CEG was produced similarly to the previously disclosed methods and included intercalation of CrO₃ into the interlayer spaces of graphite in a strongly acidic aqueous environment
CrO₃ Intercalation Reactions

CrO₃+2HCl↔CrO₂Cl₂+H₂O

2CrO₂Cl₂+3H₂O↔H₂Cr₂O₇+4HCl

The Cr species identified as intercalating between graphite layers is CrO₂Cl₂, a highly reactive oxidant existing in chemical equilibrium with H₂Cr₂O₇. The second step of CEG production is the addition of H₂O₂, which reacts with chromic acid and produces H₂O₂ bubbles, which push the layers of graphite apart.
Graphite Expansion Reactions:

Cr₂O₇²⁻+2H⁺+4H₂O₂↔2CrO₅+5H₂O

2CrO₅+6H⁺+7H₂O₂↔2Cr³⁺+10H₂O+7O_{2(g)}

The combined factors of high specific surface area and high electrical

conductivity of individual graphene sheets that can therefore be assumed for CEG make it an attractive candidate for hosting zinc metal plating and stripping zinc batteries.

### Alloy-Seeding Zinc Nucleation

The mechanistic framework for “alloy seeding” zinc nucleation was developed by the inventors, as shown in “Unveiling the Origin of Alloy-Seeded and Nondendritic Growth of Zn for Rechargeable Aqueous Zn Batteries” by Y. Zhang in ACS Energy Letters, 2021, 6, pp. 404-412, the content of which is incorporated herein in its whole entirety. It showed that the thermodynamic driving force to form silver-zinc alloy could eliminate nucleation overpotential and regulate zinc deposition to form dense deposits on a large number of Ag nanoparticles distributed across the substrate. The more standard approach to zinc plating without alloy-seeding results in fewer, larger deposits that become dendritic when charged to high capacity. Without alloy-seeding, the number of Zn deposits decreases, and the likelihood of dendrite formation increases when low overpotential charging is used, which is an important strategy for avoiding hydrogen evolution.

### Zinc From Electrolyte

The Zinc host is synthesized in the discharged state, empty of zinc. The cathode used in testing for this work, however, is in the charged state when full cells are to be assembled. For the operation of the full cells to begin, the anode must be charged with zinc from the electrolyte while oxygen is evolved at the cathode by splitting water. Acid is left behind when water splits and oxygen is evolved, and this acid reacts with ZnO, which is added to cells for this purpose to renew the electrolyte's zinc ion concentration. The electrochemical and chemical reactions during the first charge of the zinc-air battery in a mildly acidic electrolyte with a zinc host anode are shown below.
Electro-Reduction of Zinc (at the anode):

Zn_{(aq)}²⁺+2e⁻→Zn₍ₛ₎
Oxygen evolution (at the cathode):

6H₂O₍ₗ₎→O_{2(aq)}+4H₃O_{(aq)}⁺+4e⁻
Zinc ion regeneration (in the electrolyte):

ZnO₍ₛ₎+2H₃O_{(aq)}⁺→Zn_{(aq)}²⁺+3H₂O₍ₗ₎

### EXPERIMENTAL METHODS

### Scalable Host Synthesis

Materials. Hydrochloric Acid (37% aqueous solution by weight, ACS reagent, Sigma Aldrich), Chromium (VI) Oxide (99% purity, Sigma Aldrich), Natural graphite flakes (1 mm, Sigma Aldrich), Hydrogen Peroxide (50% aqueous solution by weight, Sigma Aldrich), Silver Nitrate (99% purity, Sigma Aldrich), Sodium Borohydride (99% purity, Sigma Aldrich), water-based single-wall CNT suspension (Tubal Batt H2O 0.4% with CMC), PVDF membrane filters (47 mm diameter, 0.65 μm pore size DVPP04700 for most uses, 0.22 μm pore size GVHP04700 when filtering SWCNT, Millipore Sigma).

Equipment. Dropwise, the addition of solutions was done with a KD Scientific KDS 100 variable rate and volume lab syringe pump. Freeze drying was done with an SP Scientific SP VirTis Freeze Mobile large capacity freeze dryer, model FM25XL-70.

Method. Silver-decorated CEG host for Zinc-Air battery anode is prepared in five steps:
(1) Graphite Intercalation Complex (GIC) preparation from natural graphite flakes: Add 14 mL of 37% HCl solution to a 500 mL beaker. Add 2 g graphite flakes and 14 g CrO₃. Stir for 2 h, then recover by vacuum filtration and wash with 1600 mL DI water. Dry in a vacuum over at 60° C. for two days.
(2) Chemical expansion of graphite layers to convert GIC to CEG: Add 0.5 g GIC to a 500 mL round bottom flask. Add 60 mL of 50% H2O2 solution and 40 mL DI water. Swirl gently, then let stand for 2 days. Recover and wash with 800 mL DI water, and store the product of a 0.5 g GIC batch in water with 50 mL total volume.
(3) Silver-decoration of CEG: Add the product of a 0.5 g GIC batch of CEG to a 1000 mL beaker and bring the liquid level to 150 mL. Add 0.5 g AgNO₃ and stir gently with a large magnetic stir bar for 1 h. Dropwise, add 250 mL of 70 mmol NaBH₄ solution to the beaker. Recover and wash with 800 mL DI water, and store the product of a 0.5 g GIC batch in water with 50 mL total volume.
(4) Incorporation of SWCNT with Silver-Decorated Chemically Expanded Graphite (Ag·CEG): Dissolve 10.87 g of 0.4% SWCNT suspension in 200 mL using ultrasonication and occasional hand stirring for 1 hour, then wash with 800 mL DI water, stirring vigorously with a magnetic stir bar. Add Ag·CEG and stir by hand after CNT washing once the liquid level in the filter reservoir falls to 50 mL. Stir gently by hand and filter down to a liquid level of 37 mL. Distribute slurry into 1 cm plastic molds and freeze.
(5) Freeze-drying of Silver-decorated Chemically Expanded Graphite/Carbon Nanotube Composite (Ag·CEG·CNT) to preserve pore structure: Freeze dry, frozen Ag·CEG·CNT slurry in molds under vacuum (<100 mTorr) with condenser cooled to −85° C. for around 2 days, or until all water has been sublimed.

The product of one lab-scale production series, 3× the size of the example synthesis outlined above, is shown in FIG. 2A.

### Host Characterization

Equipment. Scanning Electron Microscopy was conducted using the Hitachi SU-8230 SEM at the GA Tech IEN/IMAT Materials characterization Facility.

Methods. SEM with 400×-500× magnification was used to evaluate the host materials' structure. For normal (above-view) SEM, the sample to be viewed is stuck on an SEM stub using conductive carbon tape. For cross-section SEM, the sample is frozen in liquid nitrogen, then snapped in half and stuck on a special SEM stub at a 90° angle to the viewing plane so that the cross section of the sample may be viewed from above.

### Beaker Cell Testing Platform

Issues with electrical connectivity and electrolyte loss during early testing with a more practically applicable zinc-air testing platform (self-supporting host, lean-electrolyte) led to a more lab-practical beaker-cell testing platform being used for the development of the 3D zinc host composite electrode material.

Materials. Zinc Trifluoromethanesulfonate (98%, Sigma-Aldrich), ZnO (Sigma-Aldrich <5 μm), 30×30 acid-resistant Nickel mesh (0.011″ wire size, Monel 400 Ni—Cu alloy, McMaster-Carr), Carbon/Manganese Oxide air cathode (Electric Fuel E4 Air Electrode), Glass fiber separator (GE Health Sciences Whatman GF6 glass fiber filters), stiff plastic mesh (McMaster-Carr), plastic fasteners (McMaster-Carr).

Methods. Ag·CEG·CNT anodes for electrochemical testing were prepared with approximately 1 cm² area and Zn host mass loading of 2-20 mg/cm². Zn host material was carefully positioned on Ni mesh and pressed into the mesh using a 10-ton press, with host and mesh sandwiched between Zn foil plates to avoid the transfer of HER catalyzing transition metal contaminants. Rectangular strips of E4 air electrode of 4-6 mm width were cut for use as a cathode. 20 mL beakers were used to house all components, with machined plastic caps holding the anode and cathode approximately 11 mm apart. 8 ml of 1 mol/L Zinc Trifluoromethanesulfonate (Zn(OTf)i) electrolyte and 300 mg excess ZnO were used.

An anode with 2.5 mg of Ag·CEG·CNT host distributed over approximately 0.7 cm² of Ni mesh is shown in FIG. 2B and the fully assembled beaker cell are shown in FIG. 2C. The testing results with the fully assembled beaker cell shown in FIG. 2C can be seen in FIG. 4A.

A modified testing platform was needed to compare the zinc host to thin zinc foil with near-equivalent areal capacity. Due to the thin zinc foil bending easily, cell geometry had to be fixed by holding electrodes in close proximity using stiff plastic mesh. The electrodes were kept from short-circuiting by a glass fiber separator. A side-on view of the components and a fully assembled comparison beaker cell are shown in FIG. 4B.

### Experimental Results and Discussion

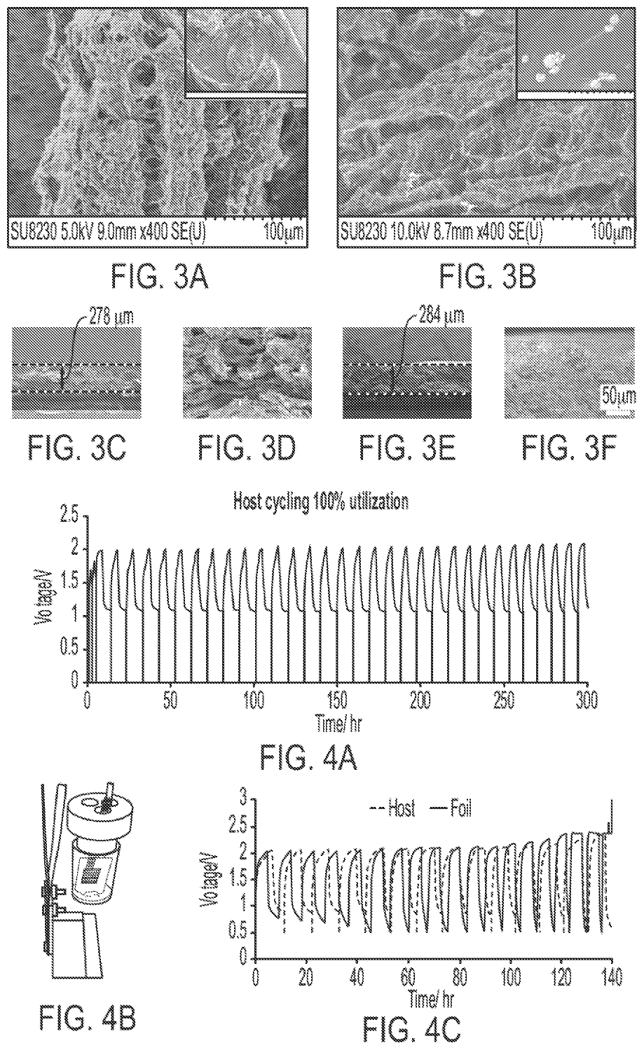

Host Characterization. The morphology of CEG can be seen in FIG. 3A, and the morphology of Ag·CEG can be seen in FIG. 3B. FIGS. 3C-3F show a cross-sectional SEM investigation of whether zinc deposits in the macropores of the material, on the most readily available surfaces, or in the interlayer spaces. The evenly textured appearance in FIG. 3F indicates that the deposition of zinc in Ag·CEG·CNT is between the graphitic layers rather than solely in the macropores of the material. Deposition in the macroporous regions alone would appear in cross section SEM as lighter regions of Zinc deposits and darker regions of graphitic layers pushed back together by the Zinc.

The Zn anode host material in FIGS. 3E and 3F was loaded in a coin cell platform with 10 mAh/cm² Zn from 2 mol/L Zinc Sulfate (ZnSO₄) aqueous electrolyte with zinc metal counter electrode.

### Beaker Cell Testing

The Ag·CEG·CNT 3D zinc host composite electrode material was found to plate and strip zinc with decent reversibility for an unoptimized secondary zinc-air system, at least for the first 20 cycles. FIG. 4A shows a relatively flat discharge around 1.15V in early cycling, as was the case for the landmark work with zinc-air batteries using Zn(OTf)₂ electrolyte and ZnO₂ chemistry.

The test comparing the Ag·CEG·CNT zinc host to zinc foil in FIG. 4C is not optimal because the current density and capacity requirements put on the air cathode and oxygen dissolved in electrolyte were too high, and failure ultimately was caused by the cathode rather than the anode. The results in FIG. 4C do, however, show better discharge voltage and longevity for the host material compared to a zinc foil anode. The failure mechanism of both cells may be due to the irreversible side reaction of zinc with MnO₂, which is known to occur but is currently poorly understood.

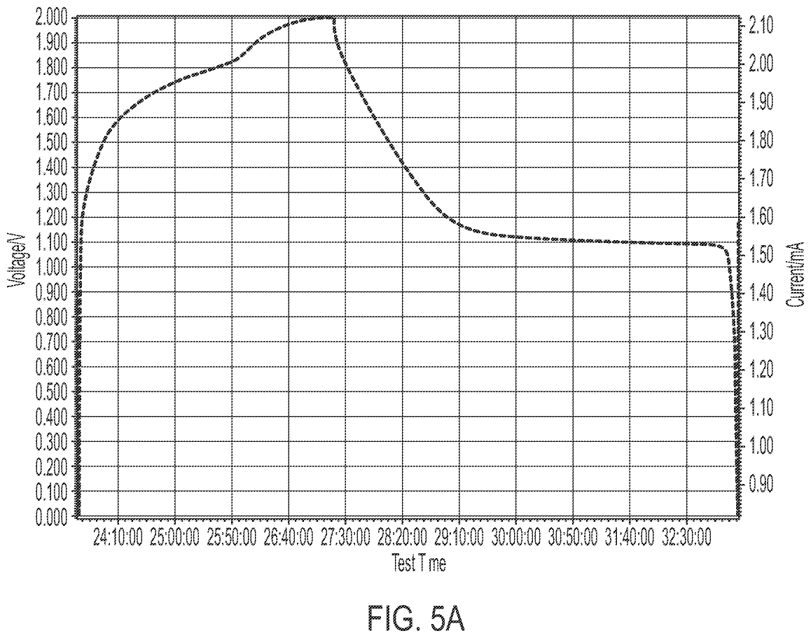

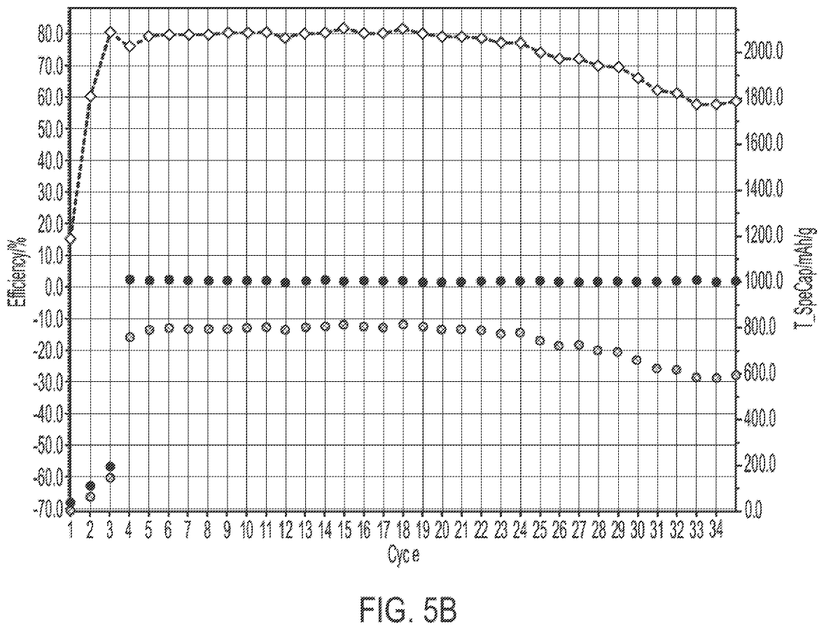

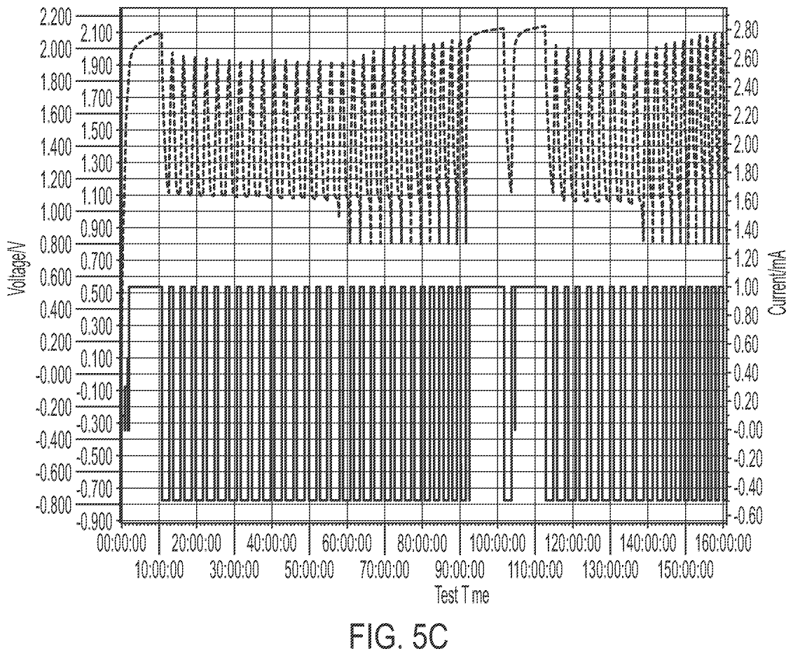

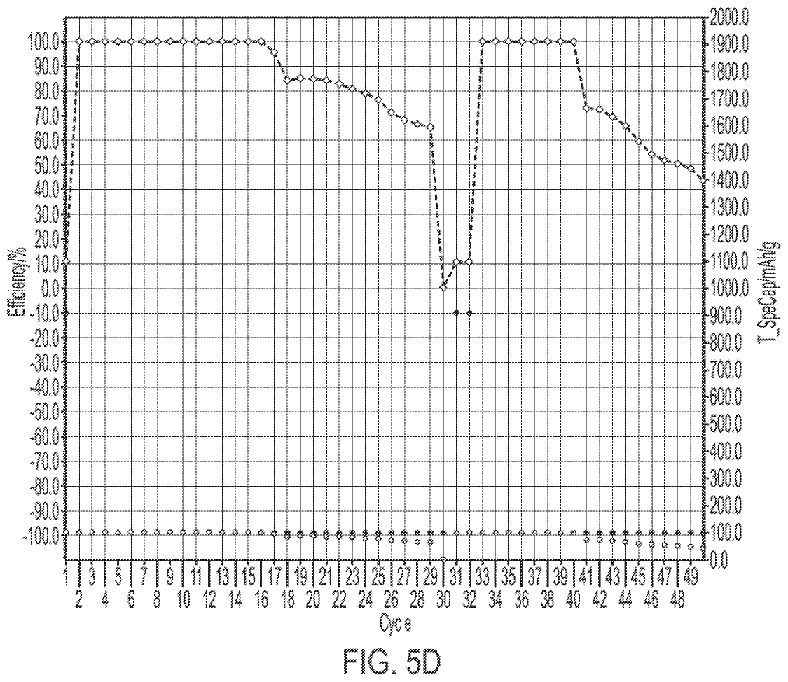

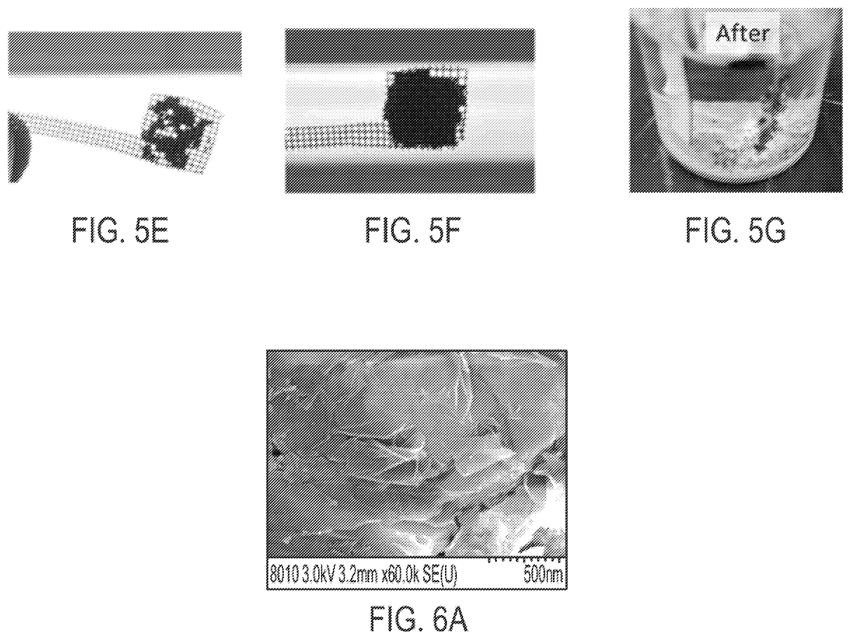

FIGS. 5A-5G expand on the results presented in FIG. 4A and provide cycling data for a shallow cycling zinc-air battery with relatively high mass loading for comparison. The charge-specific capacity, charging current density, and discharging current density are the same for the two different cells. The data in FIGS. 5A and 5B are associated with the zinc-air full cell shown in FIG. 2C, as is the data in FIG. 4A. FIG. 5C shows the Voltage profile of the shallow cycling case. It can be observed that full-cell charging voltages increase over cycling, and discharging voltages decrease over cycling. It is unclear if this change is driven by degradation at the anode, cathode, or both.

The benefits of shallow cycling are apparent in FIGS. 5A-5G. Shown in FIG. 5D, the initial full charge of the high mass loading cell enabled 16 cycles with 100% calculated Coulombic Efficiency (CE). The CE did not fall below 80% until the 26th cycle, and 100% CE was recovered for 8 cycles after a “renewal” to the fully charged state.

FIG. 5G shows the shallow cycling cell after the conclusion of its testing. Flecks of host material are visible that have been broken off of the anode by bubbles of evolving hydrogen, which can still be seen adhering to the anode. Also noticeable is yellow on the ZnO lining the bottom of the beaker cell. A speculative hypothesis about this discoloration is that it may be the result of zinc depletion in the electrolyte or the product of some air electrode additive precipitating out as zinc reacts with MnO₂. As seen in FIG. 5G, the host anode develops a significant amount of bubbles over the course of cycling. As is the case with all high specific surface area zinc anodes, hydrogen evolution is a problem that must be dealt with if this zinc host material is ever to become viable. Iron nanoparticles in the carbon nanotube precursor solution seem to be the most likely candidates for the source of this hydrogen evolution problem, though, of course, zinc metal corrosion plays an unavoidable part as well. More research is needed into electrolyte additives for mildly acidic electrolytes, which increase the overpotential of hydrogen evolution due to effects on the surface or the boundary layer.

### Example 2

In this example, Zn powders doped with In and Bi were purchased from Grillo-Werke AG. Without wishing to be bound by any theory, it is hypothesized that the doping of Zn with In and Bi suppresses hydrogen evolution on the Zn anode.

The typical slurry was prepared by mixing 141.6 mg Zn powder, 19.8 mg silver nitrate, 20.7 mg high barrier graphene (HB01, from Deyang Carbonene Technology), 0.3 mL of CMC suspension mixed with SBR and 0.275 mL of water. The slurry was mixed using a centrifugal mixer (Thinky) and manually spread onto copper foil using a doctor's blade. The gap thickness on the doctor's blade can adjust the mass loading of the electrode.

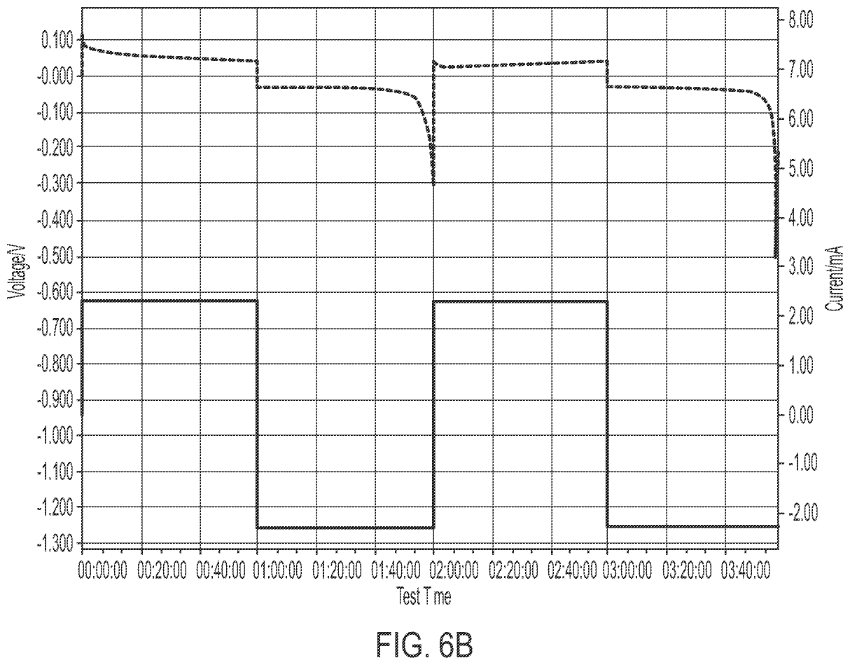

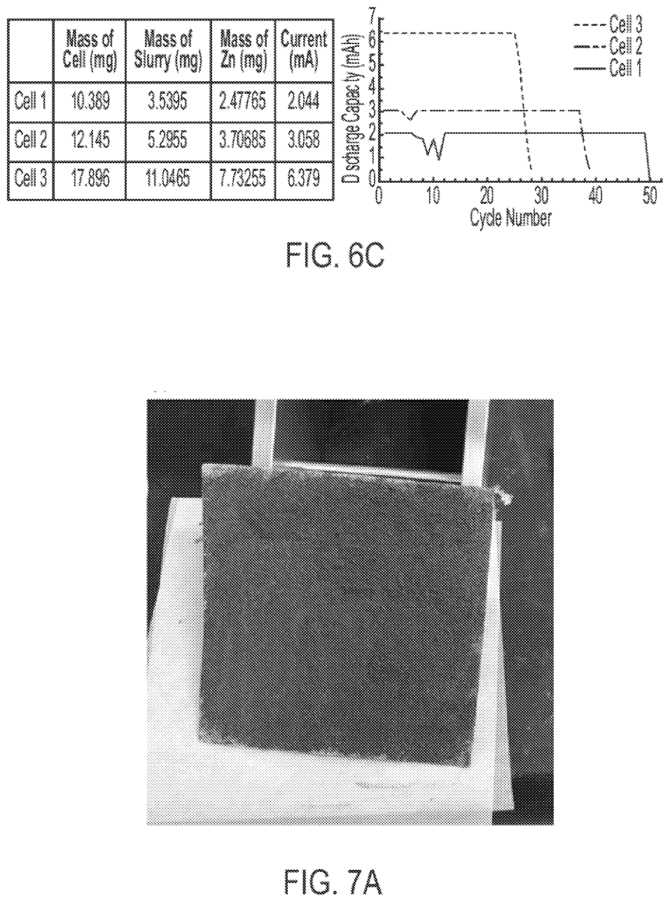

After complete drying, the electrodes were cut into round disks with 1 cm² and roll-pressed to enhance the electrical connection. The mass was measured using a microbalance by subtracting the mass of blank copper foil disks of the same size. FIG. 6A shows an SEM image of a silver-seeded electrode (ASH-1). Graphene and Zn particles can be clearly identified.

The AS1 electrodes were tested as working electrodes in 2032 coin-type cells. The casings, spacers, and springs were cleaned with acetone under sonication. The electrolyte used in the cell was 1M Zn(OTf)₂. Whatman glass fiber was used as a separator. Zn foil was used as a counter electrode. The cells were galvanostaticly cycled at a 1 C rate with a capacity and voltage limit. The capacity limit was calculated as the theoretical specific capacity (825 mAh/g) multiplied by the mass of the zinc in the electrode. The voltage limit was +0.5V during charging and −0.5V during discharging.

FIG. 6B shows the typical voltage profile of ASH-1 electrodes tested using the above method. Since the ASH-1 electrode is the working electrode, the cell was first charged (Zn striping from ASH-1 and Zn plating on Zn foil counter electrode). Full capacity is reached in the first charge, indicating all the Zn in the ASH-1 electrode participated in the reaction. More impressively, in discharge, all the capacity can be retrieved, indicating the cavities left behind during charge can be refilled by Zn in discharge. This striping and refilling process was found to be highly reversible, owing to the ASH-1 design.

The ASH-1 electrodes were tested with varying mass loadings. The mass loadings and corresponding performance are summarized in FIG. 6C. It was demonstrated that all the cells have 100% utilization. The 2 mAh/cm² cell was able to maintain the capacity for 50 cycles, while the 6.4 mAh/cm² cell was able to maintain the capacity for 26 cycles.

### Example 3

In this example, a different formulation for ASH Zn anodes (ASH-2) was prepared. The composition of ASH-2 electrodes was formed by replacing graphene with carbon particles in the slurry. The new slurry is prepared by mixing 140.4 mg Zn powder, 20.4 mg silver nitrate, 20 mg super P black (from MTI), 0.3 mL of CMC suspension mixed with SBR (from MTI) and 0.275 mL of water. The slurry was well mixed using mortar and pestle and manually spread onto copper foil using a doctor's blade. The mass loading of the electrode can be adjusted by the gap thickness on the doctor's blade.

After complete drying, the electrodes were cut into round disks with 1 cm² and roll-pressed to enhance the electrical connection. The mass was measured using a microbalance by subtracting the mass of blank copper foil disks of the same size.

### Battery Testing

The ASH-2 electrodes were tested as working electrodes in 2032 coin-type cells. The casings, spacers, and springs were cleaned with acetone under sonication. 1M Zn(OTf)₂ was used as an electrolyte. The Whatman glass fiber was used as a separator, and Zn foil as a counter electrode. The cells were galvanostaticly cycled at a 1 C rate with a capacity limit and voltage limit.

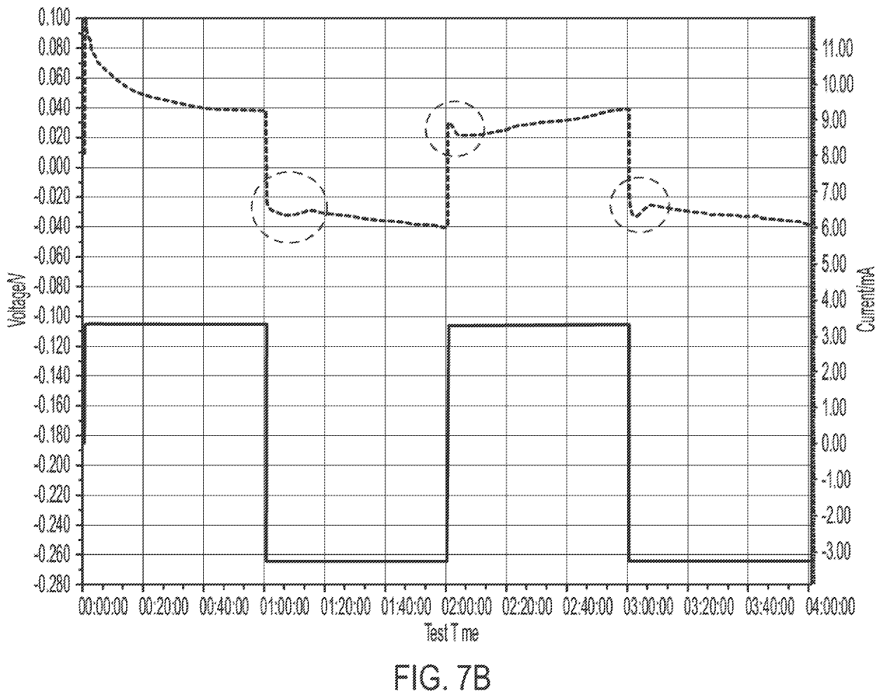

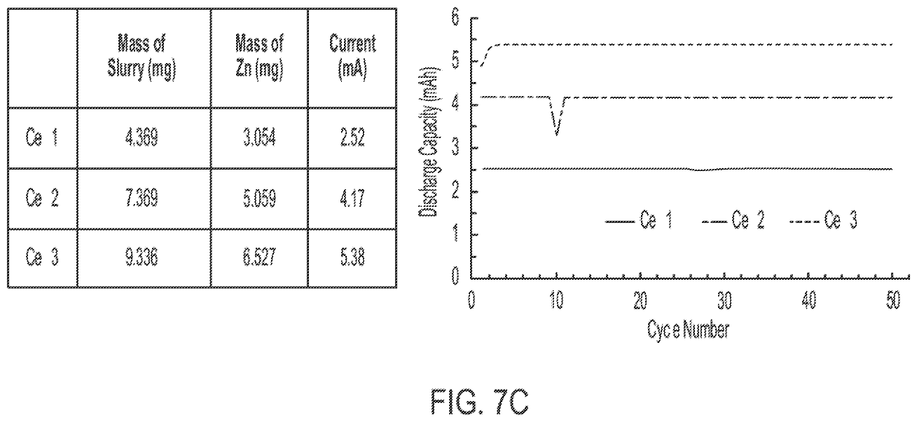

FIG. 7A shows a photograph of a large electrode prepared by the methods disclosed herein. The shown electrode has a dimension of 3″×3″, but even larger electrodes (such as, for example, 9″×21″) can also be prepared.

FIG. 7B shows the typical voltage profile of ASH-2 electrodes that were tested using the above method. Since the ASH-2 electrode is the working electrode, the cell was first charged (Zn striping from ASH-2 and Zn plating on Zn foil counter electrode). Full capacity is reached in the first charge, indicating all the Zn in the ASH-2 electrode participated in the reaction. More impressively, in discharge, all the capacity can be retrieved, indicating the cavities left behind during charge can be refilled by Zn in discharge. This striping and refilling process is highly reversible, owing to the successful ASH design. Interestingly, the voltage profile shows voltage overshoots in both charge and discharge (highlighted by three yellow circles), except for the first charge.

The ASH-2 electrodes were tested with Zn mass loadings from 2.5 to 5.5 mAh/cm². The mass loadings and corresponding cycling performance are summarized in FIG. 7C. Note that all the cells have 100% utilization and maintain the capacity for more than 50 cycles. The cycle life at >5 mAh/cm² mass loading was at least 50 cycles.

### Example 4

In this example, the enhanced the areal capacity (mAh/cm²) of alloy-seeded hosted (ASH) Zn anodes was increased by replacing Cu foil current collector with Cu foam, which is capable of hosting more active material. The areal capacity reached 31-33 mAh/cm². These high-loading electrodes were able to deep-cycle 20-40 times, after which soft breakdown happened.

Fabrication of 30 mAh/cm² ASH-2 Electrodes

The new slurry is prepared by mixing 140 mg Zn powder, 20 mg silver nitrate, 20 mg super P black (from MTI), 10 mg of CMC, 10 mg of SBR (from MTI) and 0.275 mL of deionized water. The slurry was mixed using a centrifugal mixer (Thinky) and mortar and pestle in sequence. The obtained slurry is spread onto a copper foam layer by layer using a metal scraper until reaching the desired mass loading.

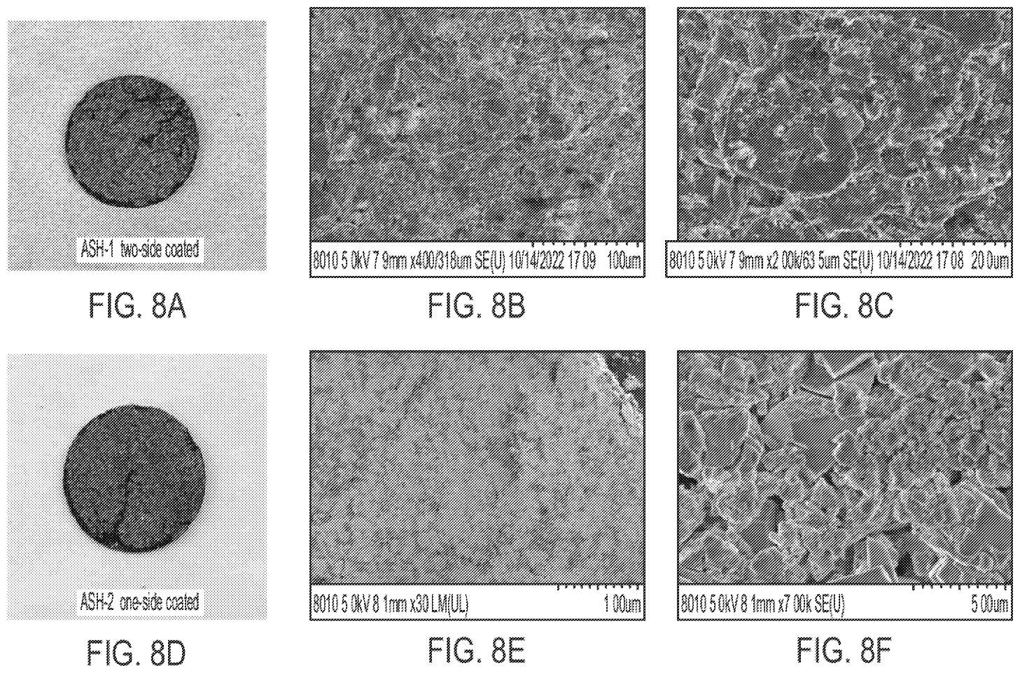

After complete drying, the electrodes were cut into round disks with 1 cm² and roll-pressed to enhance the electrical connection. FIGS. 8D-8F show the morphology of the as-prepared electrodes. The mass was measured using a microbalance by subtracting the mass of blank copper foil disks of the same size.

### Battery Testing

The ˜30 mAh/cm² ASH-2 electrodes were tested as working electrodes in 2032 coin-type cells. The casings, spacers, and springs were cleaned with acetone under sonication. The electrolyte, the separator and the counter electrode were the same as disclosed in the examples above. The cells were galvanostaticly cycled at a 1 C rate with a capacity limit and voltage limit. The capacity limit is the theoretical specific capacity (820 mAh/g) multiplied by the mass of the zinc in the electrode. The voltage limit is +0.5V during charging and −0.5V during discharging.

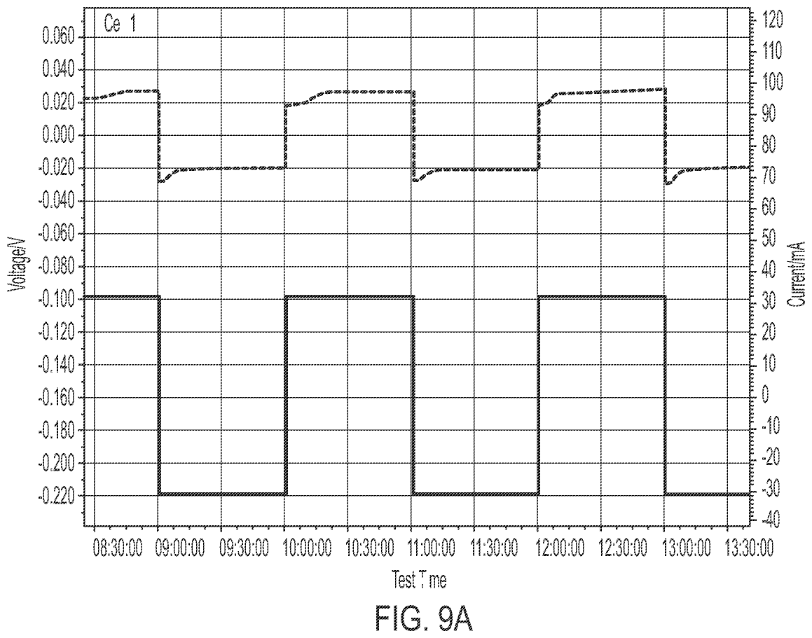

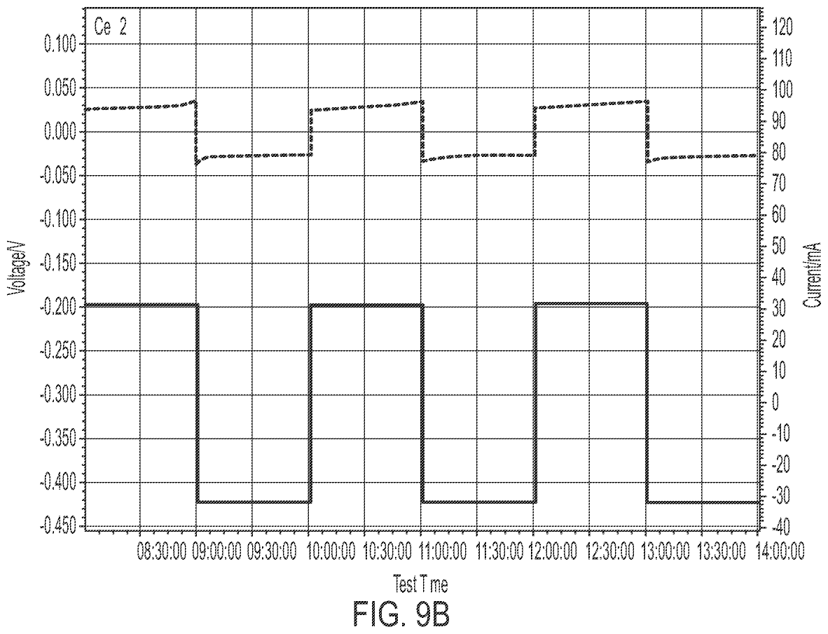

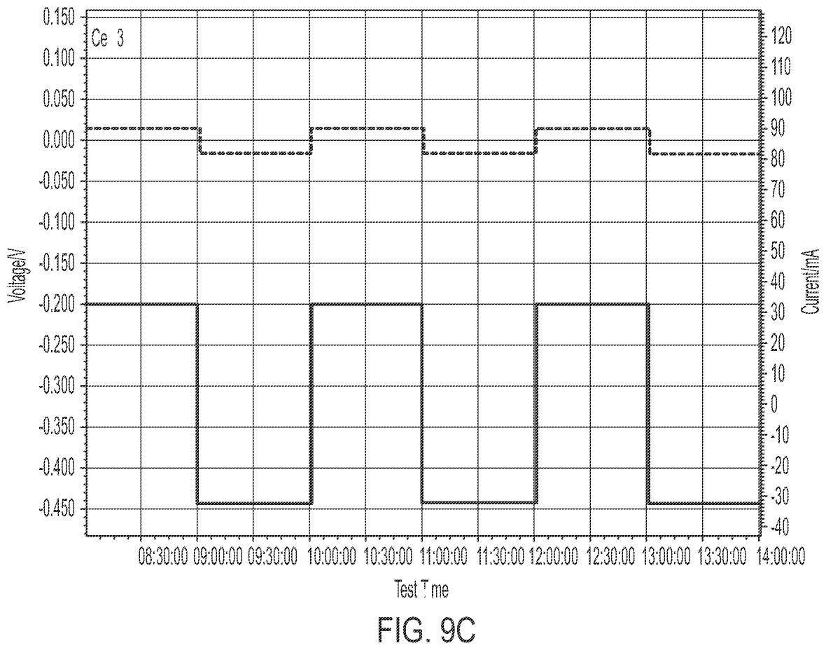

FIGS. 9A-9C show the typical voltage profile of three ˜30 mAh/cm² ASH-2 electrodes tested using the above method. During the discharge process, the capacity was fully retrieved, indicating the cavities left behind during the charge can be refilled by Zn in discharge. This striping and refilling process is highly reversible, owing to the successful ASH design. In the first ten stripping/plating cycles, all cells exhibit overpotentials of only 20 mV at high current densities of 31 to 33 mA/cm².

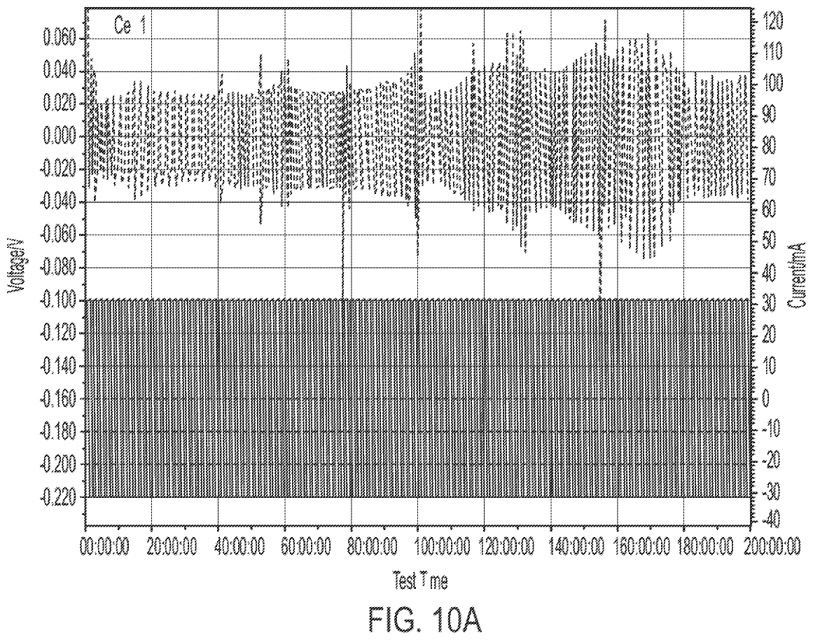

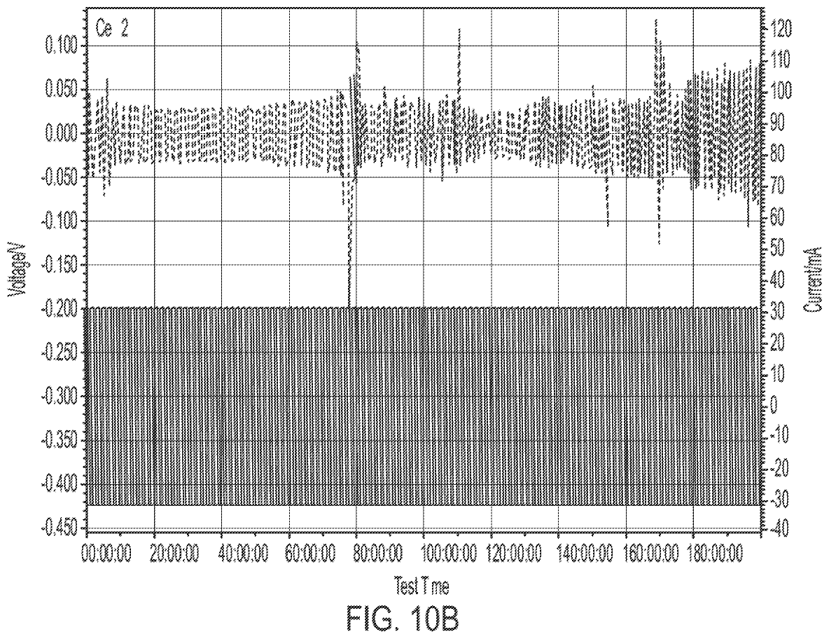

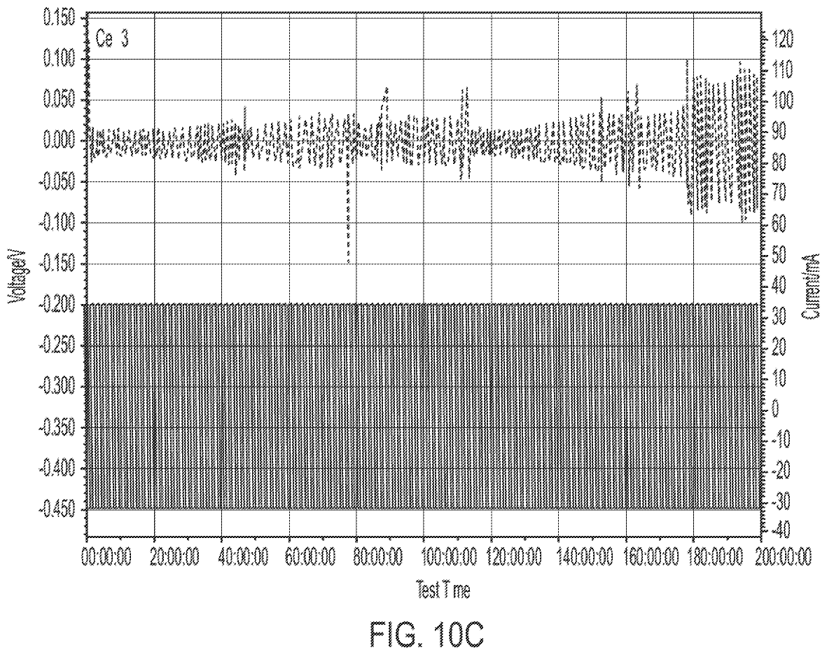

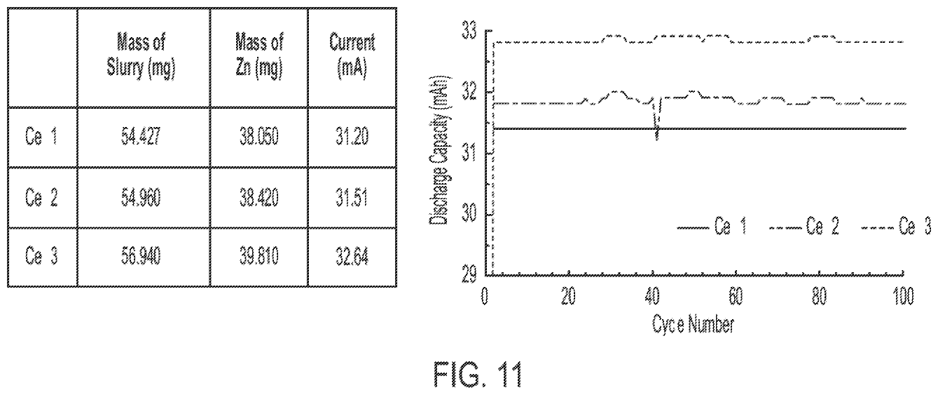

These cells' long-term cycling results are shown in FIGS. 10A-10C. The voltage profiles of all tested cells are stable for 20 to 40 cycles, with a gradual increase of polarization, which is mainly due to the formation of an insulating byproduct on the electrode or degradation of electrolyte. After 20 to 40 cycles (each cycle is composed of 1-hr charge and 1-hr discharge), there is a sudden drop in voltage hysteresis. Without wishing to be bound by any theory, it was speculated that this was an indication of soft breakdown caused by zinc dendrite.

The mass loadings and corresponding cycling performance are summarized in FIG. 11. Note that all the cells have 100% utilization and maintain the capacity for 100 cycles, although the real cycle life is only 20-40 cycles, as discussed above.

### Example 5

In this example, electrodes having an areal capacity of 40-60 mAh/cm² were fabricated. It was found that coating slurry on both sides of copper foam can uniformly distribute the silver seeds across the thickness of the electrode. In-situ electrochemical impedance spectroscopy (EIS) was conducted during battery cycling to confirm that there was no soft breakdown in the first 35 cycles.

The new slurry was prepared by mixing 140 mg Zn powder, 20 mg silver nitrate, 20 mg super P black (from MTI)/high barrier graphene (HB01, from Deyang Carbonene Technology), 10 mg of CMC, 10 mg of SBR (from MTI) and 0.275 mL of deionized water. The slurry was mixed using a centrifugal mixer (Thinky) and mortar and pestle in sequence. The obtained slurry was spread onto a copper foam layer by layer using a metal scraper until reaching the desired mass loading. Anode utilizing high barrier graphene was denoted as ASH-1 electrode, and anode utilizing super P black is denoted as ASH-2 electrode.

After complete drying, the electrodes were cut into round disks with 1 cm² and roll-pressed to enhance the electrical connection. FIGS. 8A-8F shows the morphology of the as-prepared electrodes. The mass was measured using a microbalance by subtracting the mass of blank copper foil disks of the same size.

### Battery Testing

The ˜30 mAh/cm² ASH-2 electrodes were tested as working electrodes in 2032 coin-type cells. All other conditions were kept similar to the examples disclosed above.

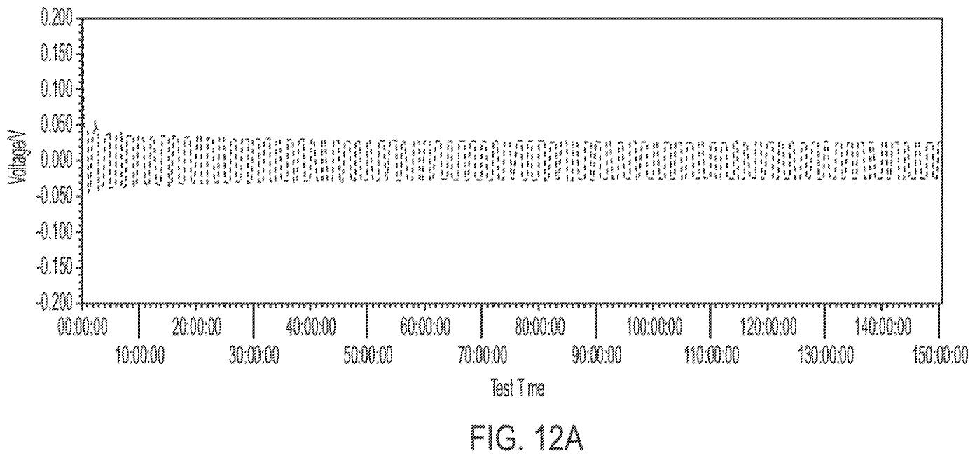

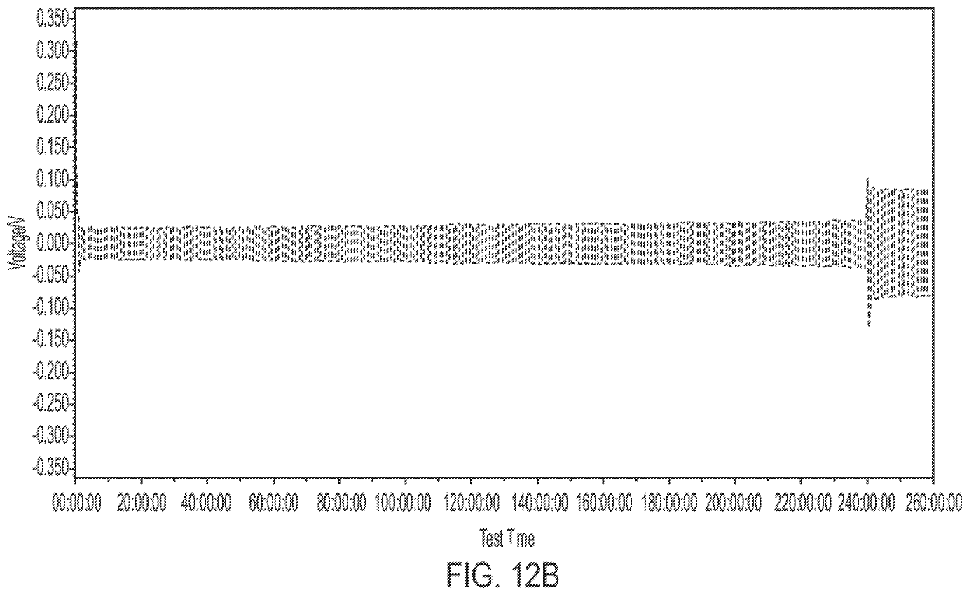

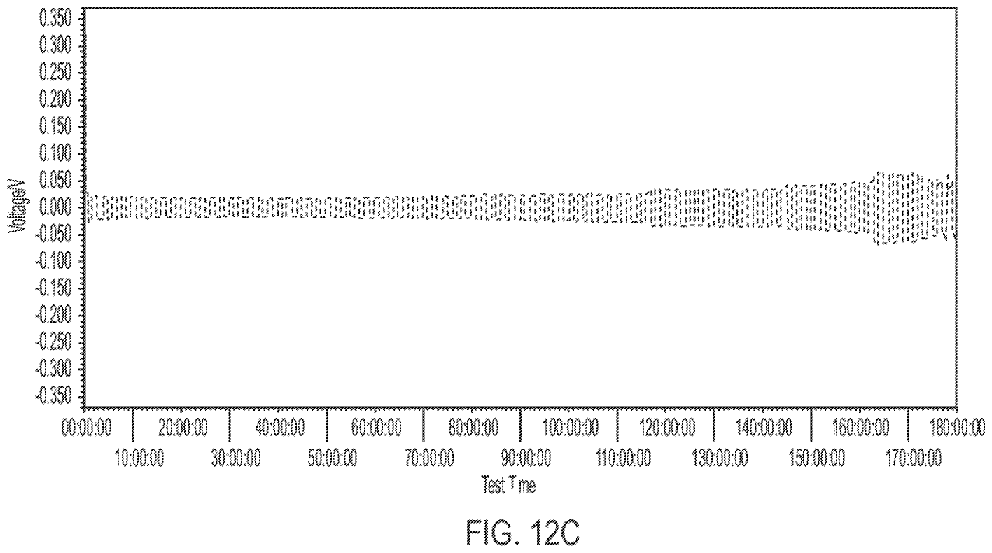

FIGS. 12A-12C show the typical voltage profile of three ASH electrodes tested using the above method. FIG. 12A show cell 1 with 41 mAh/cm² two-side coated ASH-1 electrode, FIG. 12B shows a cell with 42.3 mAh/cm² ASH-2 electrode and FIG. 12C shows cell 3 with 63.3 mAh/cm² ASH-2 electrode. All cells exhibit small overpotentials during the first 100 hours of cycling, and Cell 2 has an even longer stable cycling time of 230 hours.

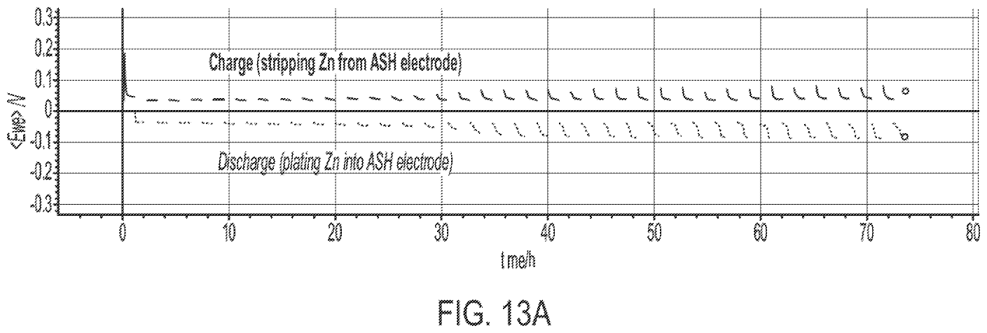

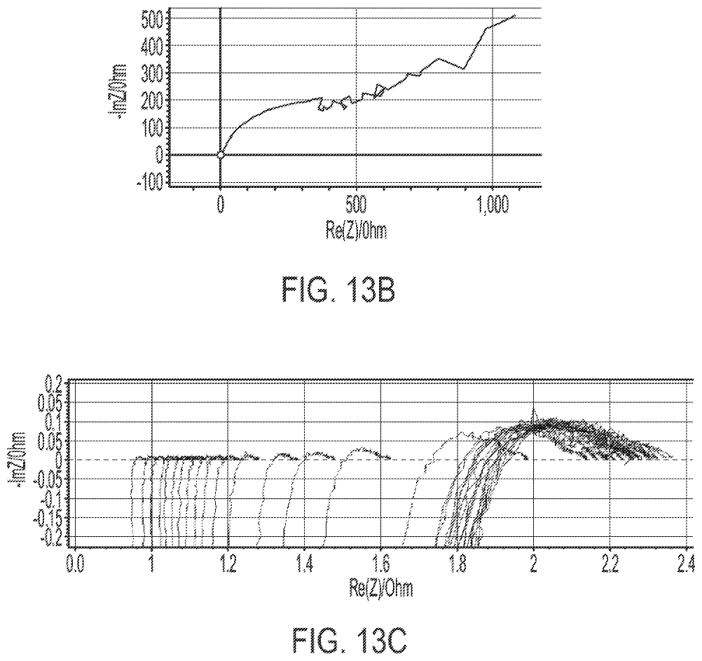

An In-situ EIS experiment was conducted to determine whether there was a short circuit during cycling. EIS was performed before cycling and after each discharge cycle. FIGS. 13A-13C show the results from the in-situ EIS experiment of the cells prepared in this example. As depicted in FIG. 13A, the voltage profiles are stable. First, EIS was conducted before battery cycling, and the result is shown in FIG. 13B. The resistance of the battery is large before cycling. However, the resistance gradually decreases during cycling, as shown in FIG. 13C with the absence of sudden change, indicating the absence of a soft breakdown.

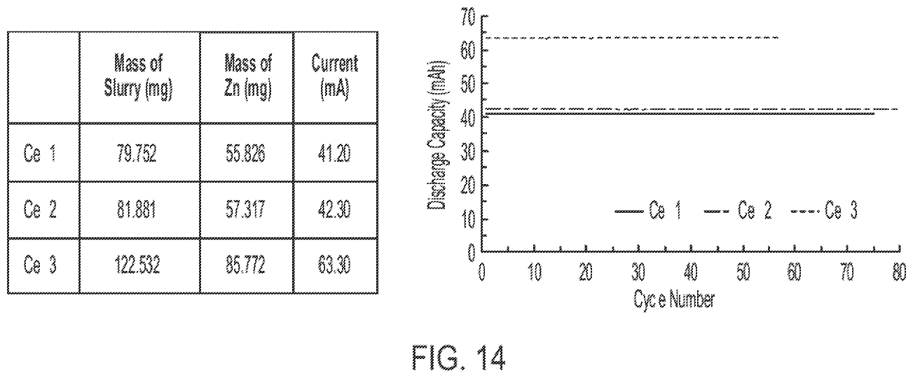

The mass loadings and corresponding cycling performance are summarized in FIG. 14. Note that all the cells have 90% utilization and maintain the capacity for 50-80 cycles. Cells tested in this example did not show a soft breakdown.

### Example 6

### Separator Selection

Four different separators, Whatman glass fiber, cellophane, Celgard, and fluorinated grafted polypropylene/polyethylene separators, were tested in Zn—Zn symmetrical cells to evaluate the sticking problem. The electrode and separator were first soaked in 10 ml of DI water for 15 min. Then the electrode and separator were carefully separated.

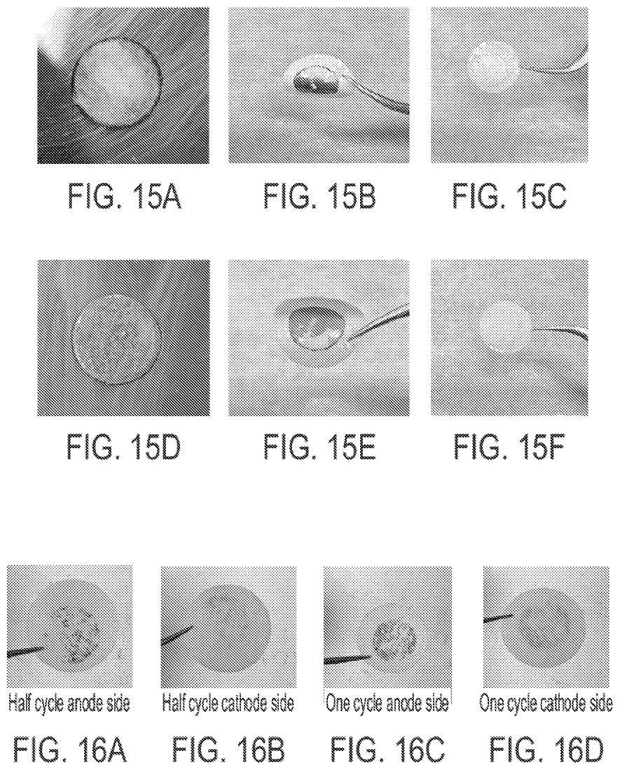

FIGS. 15A-15F show the surface of the anode side and cathode side separator after 20 cycles of charge/discharge at a current density of 40 mA/cm². Whatman glass fiber (FIGS. 15A and 15D) suffers from severe sticking problems on both sides. Celgard (FIG. 15B) has unwanted sticking problems on the anode side but no obvious sticking problem on the cathode side (FIG. 15E). Fluorinated grafted polypropylene/polyethylene separator outperforms previous separators and shows a clean surface on two sides (FIGS. 15C and 15F), so it is selected to be tested in ASH-Zn cells. The differences in the degree of residual left on the electrode can be attributed to the surface topology and surface properties.

Fluorinated grafted polypropylene/polyethylene separator was then tested in ASH-Zn cells (ASH-Zn as the “anode,” zinc foil as the “cathode”). FIGS. 16A-16D shows the two sides of the separator after half a cycle and one cycle. Compared with Whatman glass fiber, the surface is much better, and it does not stick on the surface of the anode with few residues on the separator.

### Fabrication of ASH Electrodes

The new slurry is prepared by mixing 140 mg Zn powder, 20 mg silver nitrate, 20 mg super P black (from MTI), 10 mg of CMC, 10 mg of SBR (from MTI) and 0.5 mL of deionized water. The slurry is mixed using mortar and pestle and a centrifugal mixer (Thinky) in sequence. The obtained slurry was spread onto a copper foam layer by layer using a metal scraper. The prepared copper foam with slurry is dried in air overnight.

After complete drying, the electrodes were cut into round disks with 1 cm² and roll-pressed to enhance the electrical connection. The mass was measured using a microbalance by subtracting the mass of blank copper foil disks of the same size.

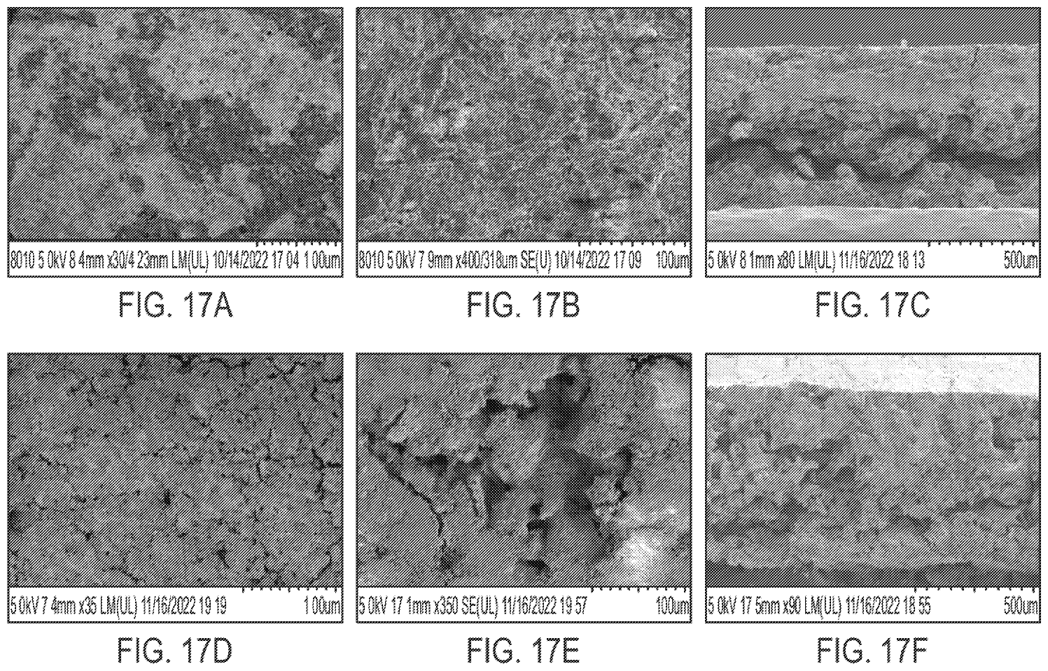

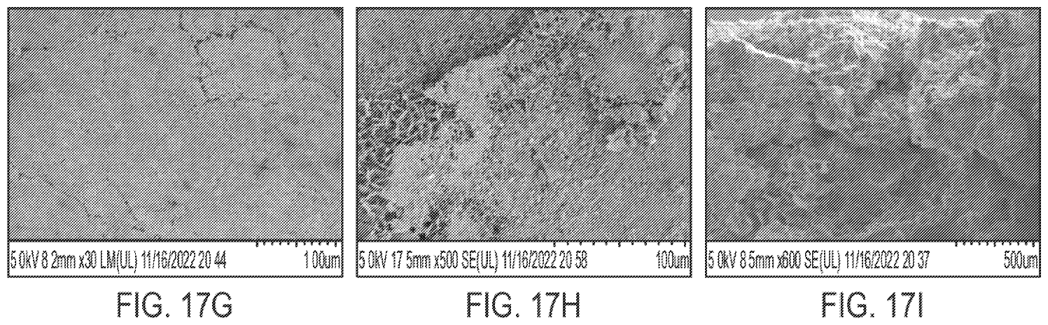

FIGS. 17A-17I exhibit the top view and cross section of pristine, Zn-stripped, and one-full-cycled ASH electrode. In FIGS. 17A and 17B, the surface of the pristine ASH electrode is compact and intact. In FIG. 17C, the slurry part is dense with no pores, which is consistent with the top-view SEM. Half-cycled ASH electrode is charged for one hour at the current density calculated from mass loading, which means that almost all the pre-loaded zinc is stripped from the anode and deposited on the cathode. In FIGS. 17D-17F, Zn-stripped ASH electrode exhibits pores and cracks. The surface morphology is consistent with the stripping process. One-full-cycled ASH electrode is the ASH electrode that goes through a complete charge and discharge process, which means zinc is stripped and then deposited back into the anode. In FIGS. 17G-17H, the surface of the ASH electrode returns to intact morphology with no pores observed, and a small amount of zinc flakes can be seen on the surface of the electrode. Notably, the large amount of zinc flakes observed underneath the surface of a one-full-cycled ASH electrode indicates that silver indeed functioned as nuclei to spatially control the growth of zinc and prevented dendrite formation on the surface of the electrode.

### Battery Testing

ASH electrodes were tested as working electrodes in 2032 coin-type cells using fluorinated grafted polypropylene/polyethylene separators. The separator is a fluorinated grafted polypropylene/polyethylene separator. The counter electrode is Zn foil. The cells were galvanostaticly cycled at a 1 C rate with a capacity limit and voltage limit. The capacity limit is the theoretical specific capacity (820 mAh/g) multiplied by the mass of the zinc in the electrode. The voltage limit is +0.5V during charging and −0.5V during discharging.

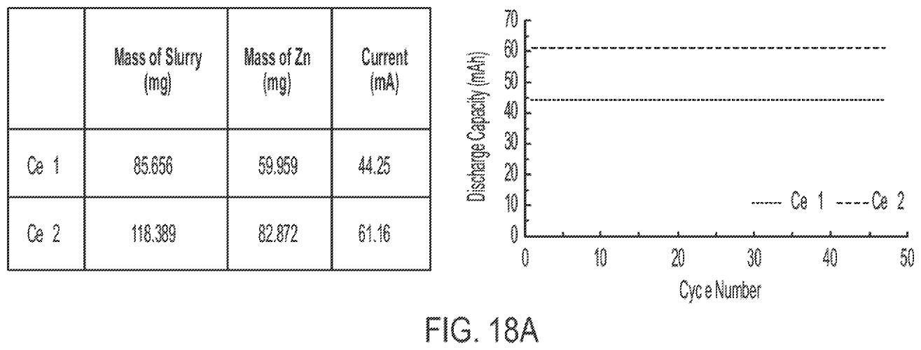

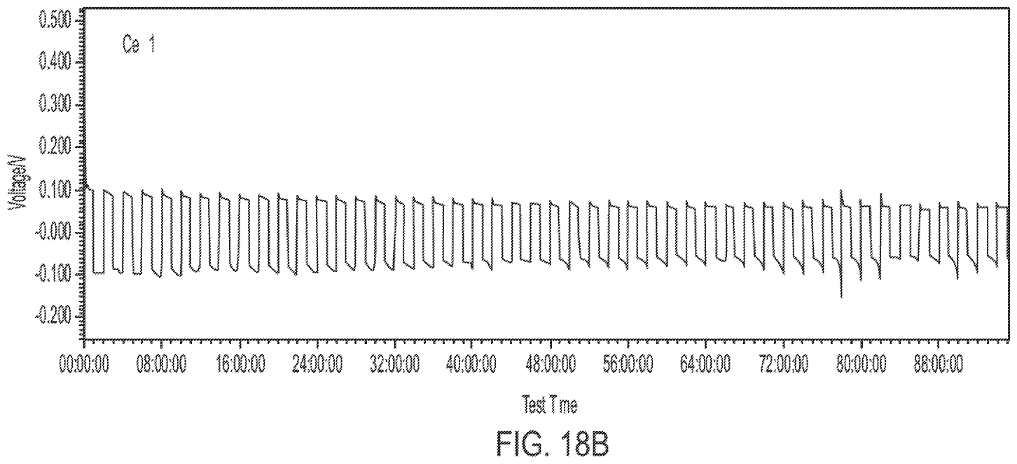

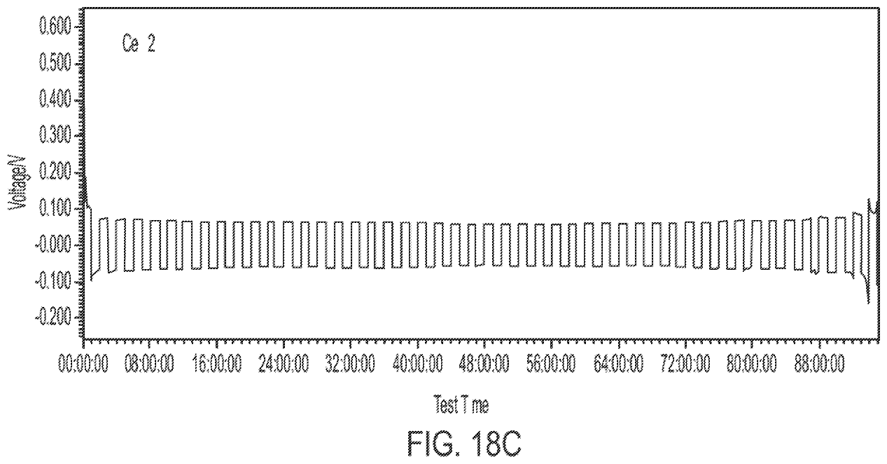

FIGS. 18A-18C shows the typical voltage profile of ASH electrodes tested using the above method. During the discharge process, the capacity was fully retrieved, indicating the cavities left behind during the charge can be refilled by Zn in discharge. This striping and refilling process is highly reversible, owing to the successful ASH design. All cells exhibit small overpotentials during the first 93 hours of cycling.

### Example 7

### Fabrication of ASH Electrodes

The slurry is prepared by mixing 140.4 mg Zn powder, 20.4 mg silver nitrate, 20 mg super P black (from MTI), 0.3 mL of CMC suspension mixed with SBR (from MTI) and 0.5 mL of water. The slurry is mixed using mortar and pestle and a centrifugal mixer (Thinky) in sequence. The obtained slurry is spread onto a copper foam layer by layer using a metal scraper. The prepared copper foam with slurry is dried in air overnight. Slurry-coated counter electrodes are prepared using the same material and procedure mentioned above without adding Zn powder.

After complete drying, the electrodes were cut into round disks with 1 cm² and roll-pressed to enhance the electrical connection. The mass was measured using a microbalance by subtracting the mass of blank copper foil disks of the same size.

### Battery Testing

The ASH electrodes were tested as working electrodes in 2032 coin-type cells. The casings, spacers, and springs were cleaned with acetone under sonication. The electrolyte is 1M Zn(OTf)₂. The separator is a fluorinated grafted polypropylene/polyethylene separator. The counter electrode is a Zn foil or slurry-coated electrode. The cells were galvanostaticly cycled at a 1 C rate with a capacity limit and voltage limit. The capacity limit is the theoretical specific capacity (820 mAh/g) multiplied by the mass of the zinc in the electrode. The voltage limit is +0.5V during charging and −0.5V during discharging.

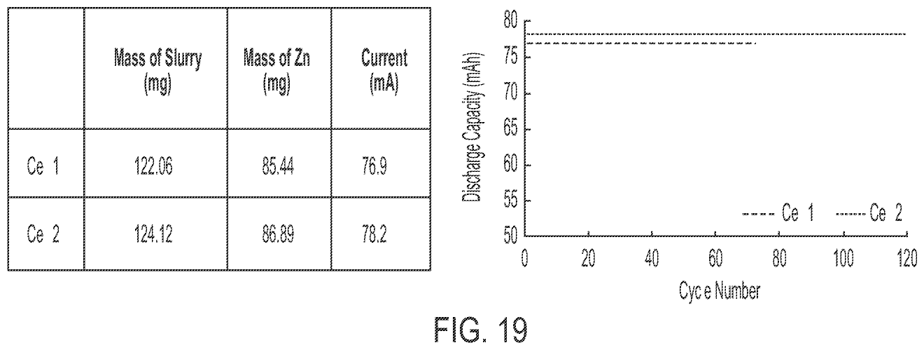

ASH electrodes were tested with Zn mass loadings from 76.9 to 78.2 mAh/cm². The mass loadings and corresponding cycling performance are summarized in FIG. 19. Note that all the cells have 90% utilization and maintain the capacity for more than 70 cycles. The cycle life at >76 mAh/cm² mass loading (at least 70 cycles) is even longer than any reported results before.

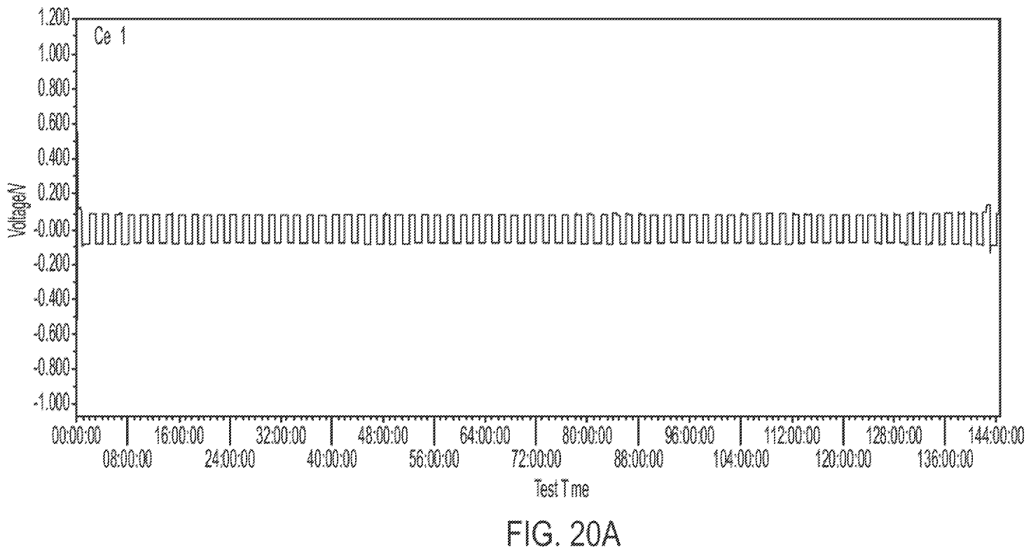

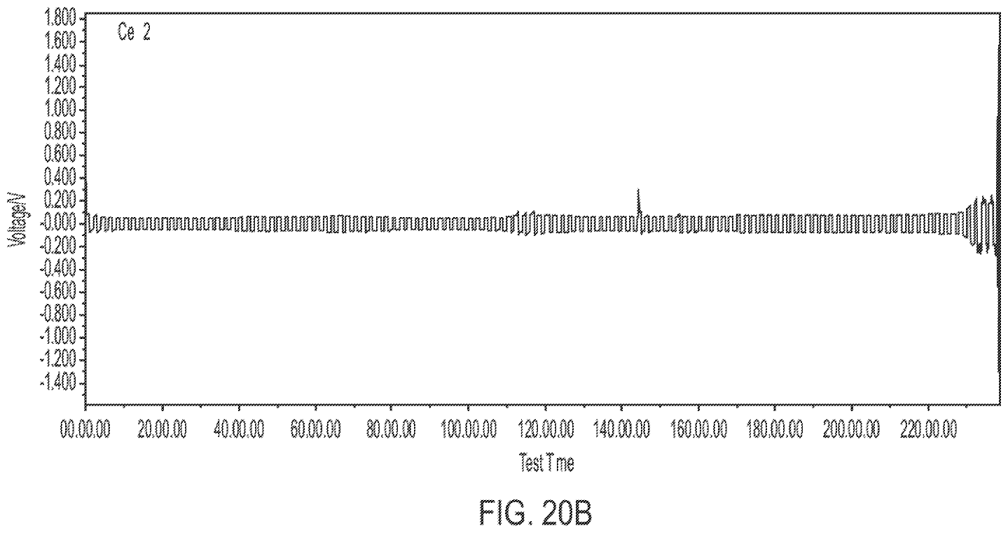

FIGS. 20A-20B shows the voltage profiles of the two cells in FIG. 19. Since the ASH electrode is the working electrode, the cell is first charged (Zn striping from ASH and Zn plating on the Zn foil counter electrode). Full capacity is reached in the first charge, indicating all the Zn in the ASH electrode participated in the reaction. More impressively, in discharge, all the capacity can be retrieved, indicating the cavities left behind during charge can be refilled by Zn in discharge. This striping and refilling process is highly reversible, owing to the successful ASH design. All cells exhibit small overpotentials during the first 144 hours (at least) of cycling with 100% coulombic efficiencies.

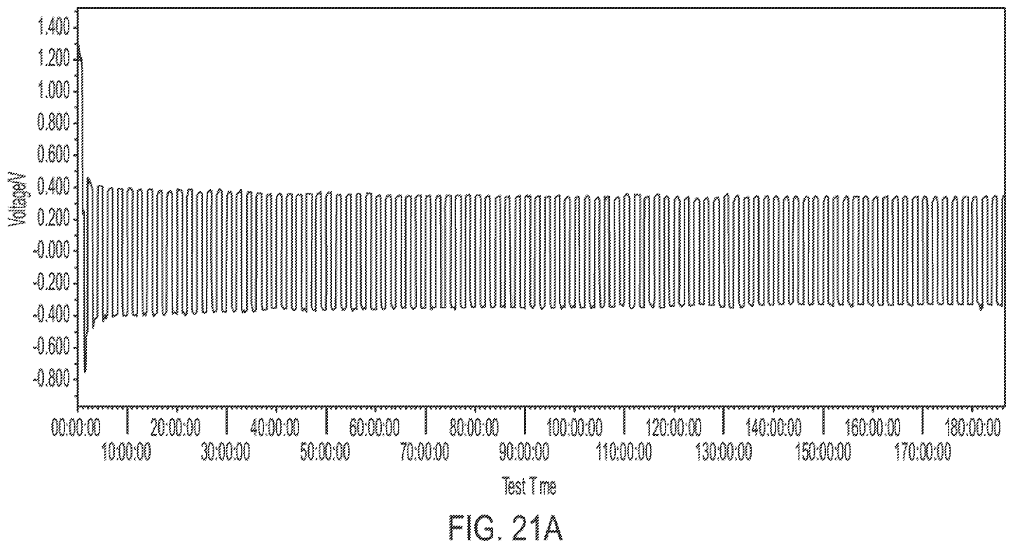

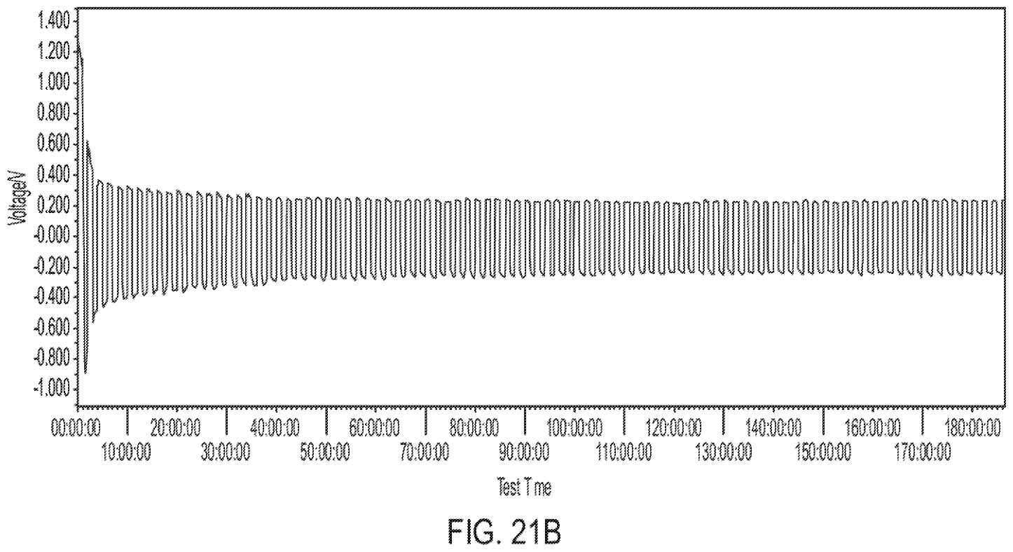

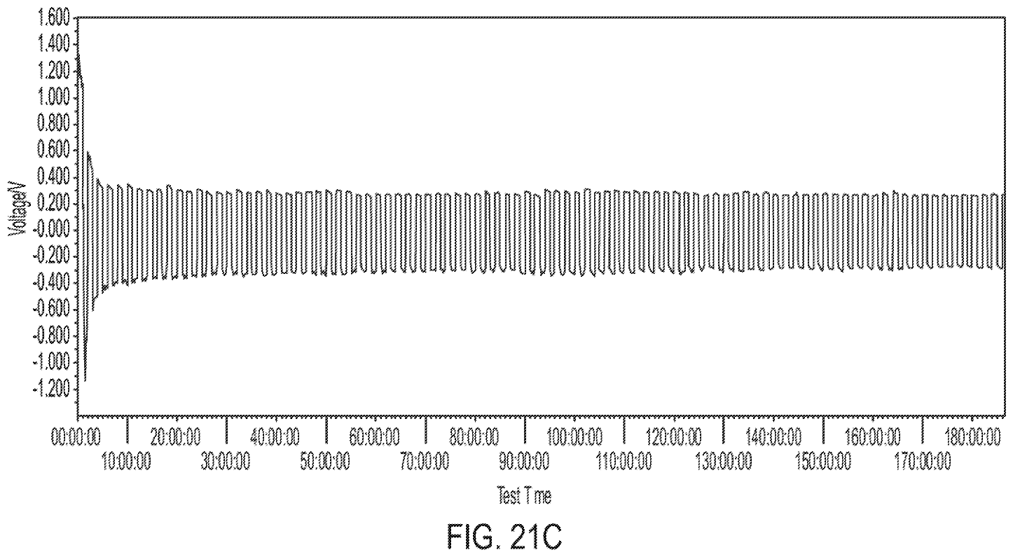

FIGS. 21A-21C show the typical voltage profile of ASH electrodes evaluated with slurry-coated counter electrodes as described earlier. By replacing Zn foil counter electrodes with slurry-coated counter electrodes, it was ensured that the cell is not limited by the short cycle life of Zn foil counter electrodes, which may fail before the ASH electrodes. When evaluated at low mass loading (5-8 mAh/cm²), the voltage profiles of all three cells are very stable and similar, indicating the reliability of this approach. The zinc striping and refilling process is highly reversible, owing to the successful ASH design. All cells exhibit small overpotentials during 190 hours of cycling.

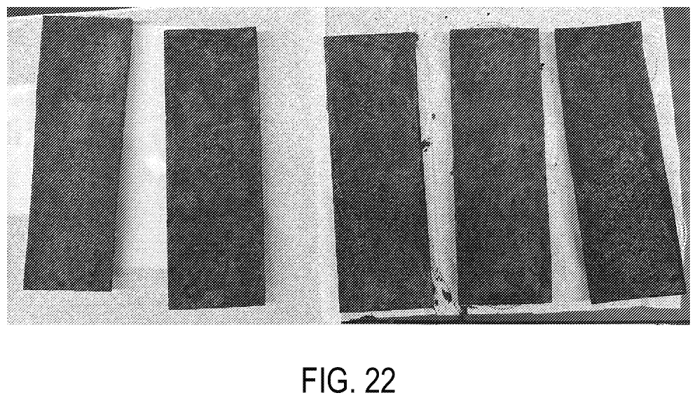

FIG. 22 shows exemplary 3-inch×9-inch ASH electrodes that were prepared as disclosed herein. The designed areal capacity for the large electrode is 50 mAh/cm².

The devices, systems, and methods of the appended claims are not limited in scope by the specific devices, systems, and methods described herein, which are intended as illustrations of a few aspects of the claims. Any devices, systems, and methods that are functionally equivalent are intended to fall within the scope of the claims. Various modifications of the devices, systems, and methods, in addition to those shown and described herein, are intended to fall within the scope of the appended claims. Further, while only certain representative devices, systems, and method steps disclosed herein are specifically described, other combinations of the devices, systems, and method steps also are intended to fall within the scope of the appended claims, even if not specifically recited. Thus, a combination of steps, elements, components, or constituents may be explicitly mentioned herein or less; however, other combinations of steps, elements, components, and constituents are included, even though not explicitly stated.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove and that many modifications and other embodiments are intended to be included within the scope of the appended claims. Moreover, although specific terms are employed herein, as well as in the claims which follow, they are used only in a generic and descriptive sense and not for the purposes of limiting the described invention or the claims which follow.

Unless defined otherwise, all technical and scientific terms used herein have the same meanings as commonly understood by one of skill in the art to which the disclosed invention belongs. Publications cited herein and the materials for which they are cited are specifically incorporated by reference.

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### EXEMPLARY ASPECTS

In view of the described processes and compositions, hereinbelow are described certain more particularly described aspects of the disclosures. These particularly recited aspects should not, however, be interpreted to have any limiting effect on any different claims containing different or more general teachings described herein, or that the “particular” aspects are somehow limited in some way other than the inherent meanings of the language and formulas literally used therein.

Example 1: An electrochemical cell comprising: an anode electrode, wherein the anode electrode comprises a conductive host material having a layered and/or a porous structure and comprising an amount of at least one zinc-alloying metal; wherein the conductive host material is configured to accommodate zinc metal deposition during a plating cycle and wherein the deposited zinc metal is substantially free of dendrites; an aqueous electrolyte; and wherein the anode electrode exhibits at least 50% utilization.

Example 2: The electrochemical cell of any examples herein, particularly example 1, wherein the conductive host material comprises a chemically expanded graphene or graphite, metal foam, conductive polymer, porous metal, or any combination thereof.

Example 3: The electrochemical cell of any examples herein, particularly example 1 or 2, wherein the metal foam comprises nickel, platinum, copper, titanium, alloys thereof, or any combination thereof.

Example 4: The electrochemical cell of any examples herein, particularly examples 1-3, wherein the at least one zinc-alloying metal comprises silver, gold, copper, tin, antimony, alloys thereof, or any combination thereof.

Example 5: The electrochemical cell of any examples herein, particularly examples 1-4, wherein the conductive host material further comprises an amount of zinc metal before the plating cycle begins.

Example 6: The electrochemical cell of any examples herein, particularly example 5, wherein the zinc metal present in the conductive host material before the plating cycle begins in a ratio of 1:1 to 10:1 to the amount of the at least one zinc-alloying metal.

Example 7: The electrochemical cell of any examples herein, particularly examples 1-6, wherein the at least one zinc-alloying metal behaves as a nucleation seed for the zinc metal deposition.

Example 8: The electrochemical cell of any examples herein, particularly examples 1-7, wherein the zinc metal is deposited within the porous structure and/or between the layers of the conductive host material during the plating cycle.

Example 9: The electrochemical cell of any examples herein, particularly examples 1-8, wherein the conductive host material further comprises carbon black, carbon nanotubes, graphene, or any combination thereof.

Example 10: The electrochemical cell of any examples herein, particularly examples 1-9, the conductive host material further comprises a binder.

Example 11: The electrochemical cell of any examples herein, particularly examples 1-10, wherein the aqueous electrolyte comprises one or more zinc salts.

Example 12: The electrochemical cell of any examples herein, particularly example 11, wherein the one or more zinc salts comprises zinc sulfate, zinc acetate, zinc citrate, zinc iodide, zinc chloride, zinc perchlorate, zinc nitrate, zinc phosphate, zinc triflate, zinc tetrafluoroborate, zinc bromide, zinc trifluoromethanesulfonate, zinc bis(trifluoromethanesulfonyl)imide, zinc bis(pentafluoroethylsulfonyl)imide, or a combination thereof.

Example 13: The electrochemical cell of any examples herein, particularly example 12, wherein the aqueous electrolyte has a pH from 4 to less than 8.

Example 14: The electrochemical cell of any examples herein, particularly examples 1-13, wherein the electrochemical cell is a battery.

Example 15: The electrochemical cell of any examples herein, particularly examples 1-14, further comprising a cathode material.

Example 16: The electrochemical cell of any examples herein, particularly example 15, wherein the cathode material comprises MnO₂, manganese-based cathodes, VS₂, Fe₂O₂, V₂O₅, Prussian blue, vanadium-based cathodes, activated carbon, or Br₂.

Example 17: The electrochemical cell of any examples herein, particularly examples 14-16, further comprising a separator.

Example 18: The electrochemical cell of any examples herein, particularly example 17, wherein the separator comprises ceramic or glass particles or fibers embedded in a polymeric matrix of textile fibers; cellulose-based film, polypropylene films, polypropylene/polyethylene films, fluorinated grafted polypropylene/polyethylene films, or a combination thereof.

Example 19: The electrochemical cell of any examples herein, particularly examples 1-18, wherein the anode electrode has a capacity from 1 mAh/cm² to 200 mAh/cm².

Example 20: The electrochemical cell of any examples herein, particularly examples 1-19, wherein the anode electrode exhibits 100% utilization.

Example 21: The electrochemical cell of any examples herein, particularly examples 14-20, wherein the battery exhibits a charge-discharge Coulombic efficiency of the cell greater than 80% for at least 50 cycles.

Example 22: The electrochemical cell of any examples herein, particularly examples 14-21, wherein the battery exhibits a charge-discharge Coulombic efficiency of the cell greater than 80% for at least 100 cycles.

Example 23: The electrochemical cell of any examples herein, particularly examples 14-22, wherein the battery exhibits a charge-discharge Coulombic efficiency of the cell greater than 99% for at least 50 cycles.

Example 24: An electrochemical cell comprising: an anode electrode, wherein the anode electrode comprises a conductive host material and comprising an amount of at least one zinc-alloying metal, wherein the conductive host material is configured to accommodate zinc metal deposition during a plating cycle and wherein the deposited zinc metal is substantially free of dendrites; an aqueous electrolyte; and wherein the anode electrode exhibits at least 50% utilization and has a capacity from 1 mAh/cm² to 200 mAh/cm².

Example 25: A system comprising one or more of the electrochemical cells of any examples herein, particularly examples 1-24.

Example 26: An article comprising the electrochemical cell of any examples herein, particularly examples 1-23 or the system of claim 25.

Example 27: A method of making an electrochemical cell comprising: a) depositing an amount of at least one zinc-alloying metal on a conductive host material having a layered and/or a porous structure; and b) plating a zinc metal on the conductive host material to form an anode electrode; wherein the anode electrode exhibits at least 50% utilization and is substantially free of dendrites.

Example 28: The method of making an electrochemical cell of any examples herein, particularly example 27, wherein the conductive host material having a deposited zinc-alloying metal is positioned in an aqueous electrolyte comprising at least one zinc-containing salt prior to the step (b) of plating the zinc metal.

Example 29: The method of making an electrochemical cell of any examples herein, particularly examples 27-28, further comprising providing a cathode electrode.

Example 30: An electrochemical storage device comprising an anode material comprising a chemically expanded graphite host intercalated with a first metal ion; and an aqueous electrolyte, wherein the first metal ion is configured to undergo a redox reaction during the operation of the electrochemical storage device.

Example 31: The electrochemical storage device of any examples herein, particularly example 30, wherein the first metal ion is zinc.

Example 32: The electrochemical storage device of any examples herein, particularly examples 30-31, wherein the chemically expanded graphite host is formed by intercalating graphite with a second metal ion.

Example 33: The electrochemical storage device of any examples herein, particularly example 32, wherein the second metal ion is chromium.

Example 34: The electrochemical storage device of any examples herein, particularly examples 30-33, wherein the chemically expanded graphite host comprises a plurality of metal particles.

Example 35: The electrochemical storage device of any examples herein, particularly example 34, wherein the plurality of metal particles comprises silver.

Example 36: The electrochemical storage device of any examples herein, particularly examples 30-35, wherein the chemically expanded graphite host comprises a plurality of nano carbon tubes.

Example 37: The electrochemical storage device of any examples herein, particularly examples 30-36, wherein the chemically expanded graphite host comprises a plurality of pores.

Example 38: The electrochemical storage device of any examples herein, particularly examples 30-37, the chemically expanded graphite host comprises a plurality of graphite layers.

Example 39: The electrochemical storage device of any examples herein, particularly examples 30-38, wherein the aqueous electrolyte comprises one or more salts of the first metal ion.

Example 40: The electrochemical storage device of any examples herein, particularly example 39, wherein the one or more salts of the first metal ion comprises zinc sulfate, zinc trifluoromethanesulfonate, or zinc bis(trifluoromethanesulfonyl)imide.

Example 41: The electrochemical storage device of any examples herein, particularly examples 30-40, wherein the aqueous solution has a pH from 4 to less than 8.

Example 42: The electrochemical storage device of any examples herein, particularly examples 30-41, further comprises a cathode material.

Example 43: The electrochemical storage device of any examples herein, particularly examples 37-42, wherein the first metal ion is deposited within at least a portion of the plurality of pores during a plating cycle.

Example 44: The electrochemical storage device of any examples herein, particularly examples 38-43, wherein the first metal ion is deposited in an interlayer space of at least a portion of the plurality of graphite layers during a plating cycle.

Example 45: The electrochemical storage device of any examples herein, particularly examples 30-44, wherein the electrochemical storage device is a rechargeable battery.

Example 46: The electrochemical storage device of any examples herein, particularly example 45, wherein the battery exhibits a charge-discharge Coulombic efficiency of the cell greater than 80% for 50 cycles.

Example 47: A method of use of electrochemical storage device of any examples herein, particularly examples 30-46.

Example 48: The method of any examples herein, particularly example 47, including each and every novel feature or combination of features disclosed herein.

Example 49: A method of making the electrochemical storage device of any examples herein, particularly examples 30-48, comprising: intercalating graphite with the second metal ion to form a chemically expanded graphite host; decorating the chemically expanded graphite host with a plurality of nanoparticles comprising silver to form a decorated chemically expanded graphite host; incorporating a plurality of carbon nanotubes a modified chemically expanded graphite host; intercalating the modified chemically expanded graphite host with the first metal ion to form an anode material.

Example 50: The compositions and methods as described in the attached specification and figures and supplemental figures.

### REFERENCES

[1] V. S. Bagotsky, A. M. Skundin, and Y. M. Koltkovich, Electrochemical Power Sources. 2015.
[2] O. Ramstrom, “Scientific Background on the Nobel Prize in Chemistry 2019—Lithium Ion Batteries,” The Royal Swedish Academy of Sciences, vol. 50005, 2019.
[3] P. Bonnick and J. R. Dahn, “A Simple Coin Cell Design for Testing Rechargeable Zinc-Air or Alkaline Battery Systems,” Journal of The Electrochemical Society, vol. 159, no. 7, 2012.
[4] Y. Zhao et al., “A Review on Battery Market Trends, Second-Life Reuse, and Recycling,” Sustainable Chemistry, vol. 2, no. 1, 2021.
[5] M. S. Ziegler and J. E. Trancik, “Re-examining rates of lithium-ion battery Technology improvement and cost decline,” Energy and Environmental Science, vol. 14, no. 4, 2021.
[6] S. Chu, Y. Cui, and N. Liu, The path towards sustainable energy, 2016.
[7] J. Hao, X. Li, X. Zeng, D. Li, J. Mao, and Z. Guo, Deeply understanding the Zn anode behavior and corresponding improvement strategies in different aqueous Znbased batteries, 2020.
[8] Y. Wu et al., “Ion-Sieving Carbon Nanoshells for Deeply Rechargeable Zn-Based Aqueous Batteries,” Advanced Energy Materials, vol. 8, no. 36, 2018.
[9] Y. Zhang, J. D. Howe, S. Ben-Yoseph, Y. Wu, and N. Liu, “Unveiling the Origin of Alloy-Seeded and Nondendritic Growth of Zn for Rechargeable Aqueous Zn Batteries,” ACS Energy Letters, vol. 6, no. 2, 2021.
[10] S. H. Park et al., “High areal capacity battery electrodes enabled by segregated nanotube networks,” Nature Energy, vol. 4, no. 7, 2019.
[11] K. Okuyama and W. W. Lenggoro, “Preparation of nanoparticles via spray route,” Chemical Engineering Science, vol. 58, no. 3-6, pp. 537-547, February 2003.
[12] R. Mueller, L. Madler, and S. E. Pratsinis, “Nanoparticle synthesis at high production rates by flame spray pyrolysis,” Chemical Engineering Science, vol. 58, no. 10, pp. 1969-1976 May 2003.
[13] S. C. Tsai, Y. L. Song, C. S. Tsai, C. C. Yang, W. Y. Chiu, and H. M. Lin, “Ultrasonic spray pyrolysis for nanoparticles synthesis,” Journal of Materials Science, vol. 39, no. 11, 2004.
[14] Y. J. Hong, M. Y. Son, and Y. C. Kang, “One-pot facile synthesis of double-shelled SnO2 yolk-shell-structured powders by continuous process as anode materials for li-ion batteries,” Advanced Materials, vol. 25, no. 16, 2013.
[15] A. Stunda-Zujeva, Z. Irbe, and L. Berzina-Cimdina, “Controlling the morphology of ceramic and composite powders obtained via spray drying—A review,” Ceramics International, vol. 43, no. 15, pp. 11543-11551, October 2017.
[16] R. Balgis, T. Ogi, A. F. Arif, G. M. Anilkumar, T. Mori, and K. Okuyama, “Morphology control of hierarchical porous carbon particles from phenolic resin and polystyrene latex template via aerosol process,” Carbon, vol. 84, no. 1, pp. 281-289, April 2015.
[17] J. Zhou, H. Zhao, J. Wang, W. Qiao, D. Long, and L. Ling, “Scalable preparation of hollow polymer and carbon microspheres by spray drying and their application in low-density syntactic foam,” Materials Chemistry and Physics, vol. 181, pp. 150-158, September 2016.
[18] M. Li et al., “Facile spray-drying/pyrolysis synthesis of core-shell structure graphite/silicon porous carbon composite as a superior anode for Li-ion batteries,” Journal of Power Sources, vol. 248, pp. 721-728, February 2014.
[19] Y. J. Hong and Y. C. Kang, “One-pot synthesis of core-shell-structured tin oxide-carbon composite powders by spray pyrolysis for use as anode materials in Li ion batteries,” Carbon, vol. 88, pp. 262-269, July 2015.
[20] B. Zou, Y. Wang, and S. Zhou, “Spray drying-assisted synthesis of LiFePO4/C composite microspheres with high performance for lithium-ion batteries,” Materials Letters, vol. 92, pp. 300-303, February 2013.
[21] T. H. Wu, Y. Zhang, Z. D. Althouse, and N. Liu, Nanoscale design of zinc anodes for high-energy aqueous rechargeable batteries, June 2019.
[22] T. F. Fuller and J. N. Harb, Electrochemical engineering/Thomas F. Fuller, (Georgia Institute of Technology, US), John N. Harb, (Brigham Young University, US), 1. 2018, vol. 1.
[23] John Denker, Standard Reduction Potentials, 2007.
[24] Y. Yan et al., “A Lasagna-Inspired Nanoscale ZnO Anode Design for High-Energy Rechargeable Aqueous Batteries,” ACS Applied Energy Materials, vol. 1, no. 11, 2018.
[25] Y. Zhang et al., “Sealing ZnO nanorods for deeply rechargeable high-energy aqueous battery anodes,” Nano Energy, vol. 53, pp. 666-674, November 2018.
[26] Y. Zhang et al., “Deeply Rechargeable and Hydrogen-Evolution-Suppressing Zinc Anode in Alkaline Aqueous Electrolyte,” Nano Letters, vol. 20, no. 6, 2020.
[27] L. Yuan, J. Xu, Z. Yang, Q. Su, and J. Li, “Zinc oxide anode modified with zeolite imidazole structure achieve stable circulation for zinc-nickel secondary battery,” Journal of Power Sources, vol. 517, p. 230 696, January 2022.
[28] J. F. Parker, I. R. Pala, C. N. Chervin, J. W. Long, and D. R. Rolison, “Minimizing Shape Change at Zn Sponge Anodes in Rechargeable Ni—Zn Cells: Impact of Electrolyte Formulation,” Journal of The Electrochemical Society, vol. 163, no. 3, 2016.
[29] T. C. Adler, F. R. McLarnon, and E. J. Cairns, “Low-Zinc-Solubility Electrolytes for Use in Zinc/Nickel Oxide Cells,” Journal of The Electrochemical Society, vol. 140, no. 2, 1993.
[30] J. F. Parker et al., “Rechargeable nickel-3D zinc batteries: An energy-dense, safer alternative to lithium-ion,” Science, vol. 356, no. 6336, 2017.
[31] M. Eisenberg, ALKALINE GALVANIC CELLS, June 1993.
[32] A. P. Pavlov, L. K. Grigorieva, S. P. Chizhik, and V. K. Stankov, “Nickel-zinc batteries with long cycle life,” Journal of Power Sources, vol. 62, no. 1, pp. 113-116, September 1996.
[33] J. McBreen, “Nickel/zinc batteries,” Journal of Power Sources, vol. 51, no. 1-2, pp. 37-44, August 1994.
[34] G. Bronoel, A. Millot, and N. Tassin, “Development of NiZn cells,” Journal of Power Sources, vol. 34, no. 3, pp. 243-255, April 1991.
[35] S. Xiong, Y. Wang, J. Yu, L. Chen, J. Zhu, and Z. Hu, “Polydopamine particles for next-generation multifunctional biocomposites,” Journal of Materials Chemistry A, vol. 2, no. 20, 2014.
[36] G. Trovati, E. A. Sanches, S. C. Neto, Y. P. Mascarenhas, and G. 0. Chierice, “Characterization of polyurethane resins by FTIR, TGA, and XRD,” Journal of Applied Polymer Science, vol. 115, no. 1, 2010.
[37] J. Song, K. Xu, N. Liu, D. Reed, and X. Li, “Crossroads in the renaissance of rechargeable aqueous zinc batteries,” Materials Today, vol. 45, pp. 191-212, May 2021.
[38] W. Sun et al., “A rechargeable zinc-air battery based on zinc peroxide chemistry,” Science, vol. 371, no. 6524, 2021.
[39] S. Lin, L. Dong, J. Zhang, and H. Lu, “Room-Temperature Intercalation and 1000-Fold Chemical Expansion for Scalable Preparation of High-Quality Graphene,” Chemistry of Materials, vol. 28, no. 7, 2016.
[40] MESH AND MICRON SIZES, November 2021.
[41] J. Mittal, H. Konno, and M. Inagaki, “Synthesis of graphite intercalation compounds with CrVI compounds using Cr03 and HCl at room temperature,” Synthetic Metals, vol. 96, no. 2, pp. 103-108, July 1998.
[42] J. Zheng et al., “Reversible epitaxial electrodeposition of metals in battery anodes,” Science, pp. 645-648, November 2019.
[43] S. Jin et al., “Stabilizing Zinc Electrodeposition in a Battery Anode by Controlling Crystal Growth,” Small, vol. 17, no. 33, 2021.
[44] J. Zheng et al., “Regulating electrodeposition morphology in high-capacity aluminium and zinc battery anodes using interfacial metal-substrate bonding,” Nature Energy, vol. 6, no. 4, 2021.
[45] M. Cui et al., “Quasi-Isolated Au Particles as Heterogeneous Seeds to Guide Uniform Zn Deposition for Aqueous Zinc-Ion Batteries,” ACS Applied Energy Materials, vol. 2, no. 9, 2019.
[46] H. Liu, Y. Zhang, C. Wang, J. N. Glazer, Z. Shan, and N. Liu, “Understanding and Controlling the Nucleation and Growth of Zn Electrodeposits for Aqueous Zinc-Ion Batteries,” ACS Applied Materials and Interfaces, vol. 13, no. 28, 2021.
[47] W. Sun et al., “Zn/MnO2 Battery Chemistry with H+ and Zn2+ Co-insertion,” Journal of the American Chemical Society, vol. 139, no. 29, 2017.
[48] B. Tang, L. Shan, S. Liang, and J. Zhou, Issues and opportunities facing aqueous zinc-ion batteries, 2019.

1. An electrochemical cell comprising:
an anode electrode, wherein the anode electrode comprises
a conductive host material having a layered and/or a porous structure and comprising an amount of at least one zinc-alloying metal comprising silver, gold, copper, tin, antimony, alloys thereof, or any combination thereof,
wherein the conductive host material further comprises an amount of zinc metal before the plating cycle begins and wherein the conductive host material accommodates zinc metal deposition during a plating cycle and wherein the deposited zinc metal is substantially free of dendrites;
an aqueous electrolyte; and wherein
the anode electrode exhibits at least 50% utilization.

2. The electrochemical cell of claim 1, wherein the conductive host material comprises a chemically expanded graphene or graphite, carbon black, carbon nanotubes, metal foam, conductive polymer, porous metal, or any combination thereof.

3. (canceled)

4. (canceled)

5. (canceled)

6. The electrochemical cell of claim 1, wherein the zinc metal is present in the conductive host material before the plating cycle begins in a ratio of 1:1 to 10:1 to the amount of the at least one zinc-alloying metal.

7. The electrochemical cell of claim 1, wherein the at least one zinc-alloying metal behaves as a nucleation seed for the zinc metal deposition.

8. (canceled)

9. (canceled)

10. The electrochemical cell of claim 1, wherein conductive host material further comprises a binder.

11. The electrochemical cell of claim 1, wherein the aqueous electrolyte comprises one or more zinc salts comprising zinc sulfate, zinc acetate, zinc citrate, zinc iodide, zinc chloride, zinc perchlorate, zinc nitrate, zinc phosphate, zinc triflate, zinc tetrafluoroborate, zinc bromide, zinc trifluoromethanesulfonate, zinc bis(trifluoromethanesulfonyl)imide, zinc bis(pentafluoroethylsulfonyl)imide, or a combination thereof.

12. (canceled)

13. The electrochemical cell of claim 1, wherein the aqueous electrolyte has a pH from 4 to less than 8.

14. The electrochemical cell of claim 1, wherein the electrochemical cell is a rechargeable battery further comprising a cathode material.

15. (canceled)

16. The electrochemical cell of claim 13, wherein the cathode material comprises MnO₂, manganese-based cathodes, VS₂, Fe₂O₂, V₂O₅, Prussian blue, vanadium-based cathodes, activated carbon, or Br₂.

17. The electrochemical cell of claim 13, further comprising a separator comprising ceramic or glass particles or fibers embedded in a polymeric matrix of textile fibers; cellulose-based film, polypropylene films, polypropylene/polyethylene films, fluorinated grafted polypropylene/polyethylene films, or a combination thereof.

18. (canceled)

19. The electrochemical cell of claim 1, wherein the anode electrode has a capacity from 1 mAh/cm² to 200 mAh/cm².

20. The electrochemical cell of claim 1, wherein the anode electrode exhibits 100% utilization.

21. The electrochemical cell of claim 13, wherein the battery exhibits a charge-discharge Coulombic efficiency of the cell greater than 80% for at least 50 cycles.

22. (canceled)

23. (canceled)

24. An electrochemical cell comprising: an anode electrode, wherein the anode electrode comprises a conductive host material and comprising an amount of at least one zinc-alloying metal, wherein the conductive host material is configured to accommodate zinc metal deposition during a plating cycle and wherein the deposited zinc metal is substantially free of dendrites; an aqueous electrolyte; and wherein the anode electrode exhibits at least 50% utilization and has a capacity from 1 mAh/cm² to 200 mAh/cm².

25. A system comprising one or more of the electrochemical cells of claim 1.

26. An article comprising the electrochemical cell of claim 1.

27. A method of making an electrochemical cell comprising:
a) depositing an amount of at least one zinc-alloying metal on a conductive host material having a layered and/or a porous structure; and
b) plating a zinc metal on the conductive host material to form an anode electrode; wherein the anode electrode exhibits at least 50% utilization and is substantially free of dendrites

28. The method of claim 27, wherein the conductive host material having a deposited zinc-alloying metal is positioned in an aqueous electrolyte comprising at least one zinc-containing salt prior to the step (b) of plating the zinc metal.

29. The method of claim 27, further comprising providing a cathode electrode.

30. An article comprising the system of claim 25.
